(19) United States
(12) Patent Application Publication
(10) Pub. No.: US 2024/0408994 A1
(43) Pub. Date: Dec. 12, 2024

(54) SYSTEM AND METHOD FOR OPTIMIZING AN ON-DEMAND TRANSPORT ARRANGEMENT SERVICE FOR RECHARGING OF VEHICLES

(71) Applicant: Uber Technologies, Inc., San Francisco, CA (US)

(72) Inventors: Michael Alexander, San Francisco, CA (US); Eric Socolofsky, San Francisco, CA (US); Ryan Alli, San Francisco, CA (US); Sachin Kansal, San Francisco, CA (US); Ian McAllister, San Francisco, CA (US); Amanda Han, San Francisco, CA (US); Lars Bergquist, San Francisco, CA (US); Betty Liu, San Francisco, CA (US); Michiko Namazu, San Francisco, CA (US); Sam Ye, San Francisco, CA (US)

(21) Appl. No.: 18/737,802

(22) Filed: Jun. 7, 2024

Related U.S. Application Data
(60) Provisional application No. 63/471,757, filed on Jun. 7, 2023.

(51) Int. Cl. B60L 53/64; G06Q 50/40

(52) U.S. Cl. CPC B60L 53/64; G06Q 50/40

(57) ABSTRACT

A network computer system determines an upcoming session during which the service provider is expected to utilize an on-demand transport service to provide, or be available to provide, transport services. The network system determines that a vehicle operated by a service provider will likely be charged during the upcoming session time. Further, the network system forecasts a demand for a service provider to provide transport services at each of a plurality of sub-intervals of the upcoming session time. The network system determines one or more sub-intervals of the plurality of sub-intervals for the service provider to charge the vehicle in order to optimize an objective of the service provider, based at least in part on the forecasted demand during one or more of the multiple sub-intervals.

### RELATED APPLICATIONS

This application claims benefit of priority to Provisional U.S. Application No. 63/471,757, filed Jun. 7, 2023; the aforementioned priority application being hereby incorporated by reference in its entirety.

### TECHNICAL FIELD

Examples pertain to optimizing an on-demand transport arrangement service for recharging vehicles.

### BACKGROUND

A network-based service can enable users to request and receive various services through one or more applications on mobile computing devices. The network-based service can assign transport providers to various tasks requested by requesting users, such as on-demand rideshare, food delivery, package delivery, and the like. The ongoing development of electric vehicles (EVs) has driven a push towards cleaner, more affordable, and more efficient means of transportation for these services.

Drivers that operate EVs currently experience an advantage over drivers of gas-powered vehicles due to the significant discount provided by electric charging versus gasoline. However, EV drivers may also experience disadvantages when servicing requests from requesting users due to the time inefficiency of charging an EV, which can take up to an hour or more. For on-demand transportation, for example, the charge time of the EV amounts to downtime for the driver, who could otherwise be generating earnings by servicing ride requests with a gas-powered vehicle.

The number of publicly available EV charging stations is increasing as the number of electric vehicles increase. An EV charging station typically provides multiple individual Electric Vehicle Supply Equipment (EVSE) ports, more commonly referred to as stalls. A single stall is typically used to charge one vehicle at a time. EV charging stations are also typically operated as part of an EV charging network. Unlike conventional fuel driven vehicles, EV charging networks include data networks that monitor usage of individual stalls, as well as the power output (which can vary based on number of stalls in use, time of day, grid condition, etc.) from individual stalls. EV networks publish information that identifies the availability of stalls, the power output, the rate charged to operators, and other information.

### BRIEF DESCRIPTION OF THE DRAWINGS

FIG. 1 illustrates an example network system for providing an on-demand transport arrangement service, according to one or more embodiments.

FIG. 2A illustrates an example method for determining whether a service provider is suitable for matching to a transport request, according to one or more embodiments.

FIG. 2B illustrates an example method for providing a recommendation data set to a service provider as to a time when the service provider should recharge a vehicle, according to one or more embodiments.

FIG. 2C illustrates another example method for determining a time during which a service provider should charge their vehicle, according to one or more embodiments.

FIG. 3A through FIG. 3N illustrate example interfaces for use with one or more embodiments.

FIG. 4A through FIG. 4C illustrate example interfaces of a service application interface that integrates a recommendation for a service provider to charge their vehicle, according to one or more embodiments.

FIG. 4D and FIG. 4E illustrate examples of a service interface on which an invitation feature is provided to enable a service provider to accept a transport request, according to one or more embodiments.

FIG. 5 is a block diagram that illustrates a network computing system upon which one or more embodiments described herein can be implemented.

FIG. 6 is a block diagram illustrating an example user device for use with examples as described.

### DETAILED DESCRIPTION

According to examples, a network computer system determines an upcoming session time during which the service provider is expected to utilize an on-demand transport service to provide, or be available to provide, transport services. The network system determines a probability score indicative of whether charging of a vehicle operated by a service provider will occur during the upcoming session time. Further, the network system forecasts a demand for a service provider to provide transport services at each of a plurality of sub-intervals of the upcoming session time. The network system determines one or more sub-intervals of the plurality of sub-intervals for the service provider to charge the vehicle in order to optimize an objective of the service provider, based at least in part on the forecasted demand during one or more of the multiple sub-intervals.

In examples, a network computer system operates to match individual drivers from transport requests based on the operational ranges of their respective vehicles. For a given service provider, the network computer system determines the operational range of a service provider's vehicle (e.g., charge level of vehicle). In determining whether the service provider is suitable to match (or candidate to match) to the transport request, the network computing system can determine a requisite distance of travel for the vehicle, where the requisite distance of travel is an estimate of the total distance the service provider has to travel to fulfill the service request and recharge the service provider's vehicle. The total driving distance can be determined from the current location of the service provider, the service start and end locations, and a service station (e.g., charging station) that is selected as being near to the service end location. For example, the total driving distance can correspond to a driving distance between the current location of the service provider and the service start location, between the service start location and the service end location, and between the service end location and the selected service station where the service provider's vehicle can be recharged. The service provider can be deemed suitable for the transport request if the current operational range of the service provider's vehicle is greater than the total travel distance for the service provider to fulfill the transport request.

Further, a network computer system can forecast a demand for the first service provider to provide transport services through an on-demand service provided by the network system. The demand can be forecasted at each of a plurality of sub-intervals in the upcoming time interval. The demand for the first service provider can be based in part on the forecasted demand for the on-demand service, as well as the forecasted number of service providers that will be available. The network system determines one or more sub-intervals for the first service provider to charge the vehicle in order to optimize an objective of the service provider, where the determination is based at least in part on (i) the predicted charge level of the vehicle at one or more of the sub-intervals, and (ii) the forecasted demand during one or more of the multiple sub-intervals. Further, in examples, the objective of the service provider can correspond to, for example, minimizing a cost of the service provider to charge the EV, and/or maximizing a usage of the service vehicle (e.g., high demand).

In some examples, the network system determines a preferred minimum operational range at which point a service provider begins to recharge their vehicle, or take steps to recharge their vehicle. In determining whether the service provider is a match (or candidate to match) to the transport request, the network system can determine (i) the current operational range of the service provider's vehicle, (ii) a difference between the current operational range and the preferred minimum operational range of the vehicle. The service provider can be deemed a match (or candidate to match) to the transport request if the determined distance of the service provider's vehicle is greater than the total travel distance for the service provider to fulfill the transport request.

Still further, a network computer system can operate to recommend upcoming or future time intervals when the service provider can recharge an EV. In examples, the network system can predict a charge level of a vehicle used by a service provider over an upcoming session time during which the first service provider utilizes the on-demand transport arrangement service to provide, or be available to provide, transport services. The predicted charge level can be based in part on the current charge level of the service provider's vehicle.

In examples, the term “operational range” means an estimated distance that a vehicle can be driven based on an amount of stored energy resource (e.g., fuel, battery charge, etc.). For example, the fuel or energy efficiency of a vehicle can reflect a distance a vehicle can travel under ideal conditions per unit of energy consumed (e.g., miles per gallon, miles per kilowatt hour (kWh)). Accordingly, in examples, the operational range can be based on a measurement of the vehicle stored energy source and the energy efficiency of the vehicle (e.g., mileage rating (“MPG”) or miles per gallon of gasoline-equivalent (e.g., “MPGe”)), where the energy efficiency of the vehicle is determined from manufacture provided information and/or through measurement and observation over time.

Further, some examples recognize that various factors can impact the energy efficiency of the vehicle. Examples of such factors include the terrain the vehicle is driven on (e.g., hilly terrain), environmental conditions (inclement weather), traffic conditions, driving style of the driver, the age of the vehicle, the condition of the vehicles tires, and other factors. Such factors can typically lower the distance the vehicle may travel per unit of energy consumed. Accordingly, in some examples, the operational range can further consider the impact of such factors on the known energy efficiency of the vehicle.

By way of example, the operational range of an EV can be represented by a charge level of its batteries. For gasoline (and derivative such as diesel) fueled vehicles, the operational capacity can correlate to a level of the fuel tank (or percentage of the fuel tank that is filled). For vehicles that are powered by fuel cell technology, the operational capacity can correlate to the amount of fuel (e.g., hydrogen) that is stored in the vehicle. Still further, many types of vehicles include multiple sources of energy for operating the vehicle. For example, hybrid vehicles can utilize gasoline and battery storage. For these cases the operational range can correlate to the fuel level of the vehicle's tank, and the charge level of the vehicle's battery.

While examples described herein primarily in context of electric vehicles, some embodiments are readily applicable to other types of vehicles, including conventional gasoline vehicles, diesel vehicles, ethanol fueled vehicles, and hydrogen fuel cell vehicles.

As used herein, the terms “optimize,” “optimization,” “optimizing,” and the like are not intended to be restricted or limited to processes that achieve the most optimal outcomes. Rather, these terms encompass technological processes (e.g., heuristics, stochastics modeling, machine learning, reinforced learning, Monte Carlo methods, Markov decision processes, etc.) that aim to achieve desirable results. Similarly, terms such as “minimize” and “maximize” are not intended to be restricted or limited to processes or results that achieve the absolute minimum or absolute maximum possible values of a metric, parameter, or variable.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

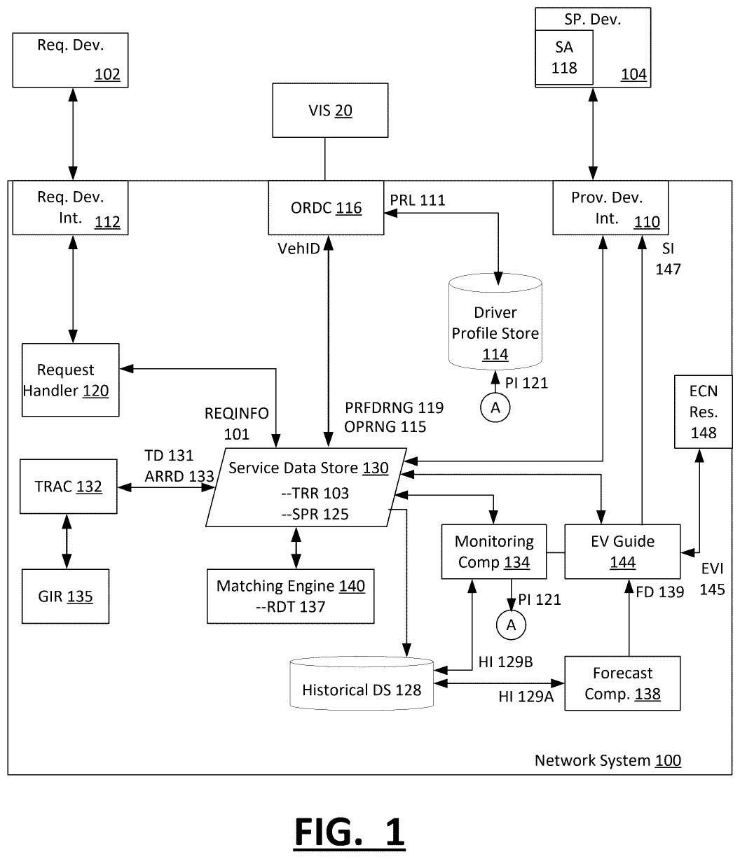

FIG. 1 illustrates a network system for providing an on-demand transport arrangement service, according to one or more examples. In examples, the users of the network system 100 include service providers (e.g., drivers who operate their own vehicles to transport riders) and requesters (e.g., riders who request and receive transport services from drivers). The transport service provided by the service provider may include a service in which the service provider operates a vehicle to transport the requester from a service start location (e.g., pickup location) to a service end location (e.g., destination or drop-off location). In variations, examples described with the network system 100 can be applied to other types of transport services, such as, for example, group transport (e.g., rider has friends or family who accompany the rider on the trip), pooled transport (e.g., driver picks up additional riders who separately request the transport service, typically with different pickup locations and/or drop-off locations), bus transport (e.g., driver transports multiple riders in large-capacity vehicle, sometimes while following a pre-determined route), or delivery transport (e.g., service provider picks up and delivers an item).

In examples, service provider operates a service application 118 on a provider device 104 to utilize in on-demand service provided by the network system 100. Service providers can interact with the service application 118 to make themselves available for providing transport services. The provider device interface 110 communicates with the provider device 104 to receive information from the service provider device 104. The information can include an identifier 107 of the service provider. The communicated information can also include a current location 109 of the service provider, such as a geographical coordinate and timestamp information. Once the service provider makes himself available, the provider device 104 can continue to communicate information, such as the location 109 of the service provider, to the network system 100. For example, the service provider can interact with the service application 118 to make himself available for the on-demand transport arrangement service, and then operate his or her vehicle to travel towards a particular direction where transport requests are more likely to be received.

The provider device interface 110 can record an entry for the service provider with the active service data store 130. The entry can include the identifier 107 and the location 109 of the service provider. The provider device interface 110 can update a corresponding service providers record 125 to reflect, for example, the current location 109 of the service provider, as well as the status of the service provider (e.g., available to provide transport, on-route to provide transport, transport in progress, paused and/or temporary unavailable to provide transport, etc.).

### Determination of Operational Range for Vehicles

The operational range determination component (“ORDC”) 116 includes processes and logic for determining an operational range of the vehicles driven by service providers. The ORDC 116 can communicate with the service data store 130 to retrieve identifiers of service providers. The ORDC 116 can use, for example, profile information associated with the service provider to access a third-party vehicle information service 20 to receive vehicle information 113 about the service provider's vehicle, where the vehicle information includes, or otherwise indicates an operational range 115 of the service provider's vehicle. The operational range can be determined from, for example, a vehicle information service that continuously communicates with vehicles in operation using an application programming interface (API) integrated into a vehicles computing system by automobile manufacturers. An example of a vehicle information service is provided by SMARTCAR US.

The ORDC 116 can update the service provider's record 125 with the operational range 115, as determined from the vehicle information service 20. Further, the ORDC 116 can repeatedly, or continuously update the service provider's record 125 with an updated value for the vehicle's operational range 115, by, for example, repeatedly polling the vehicle information service 20.

In some examples, the ORDC 116 can include logic to evaluate and further process the operational range 115 of a service provider's vehicle. For example, the ORDC 116 can evaluate the vehicle information 113 for freshness (e.g., vehicle may be in area where communication with the vehicle information service 20 is not possible), as well factors that can impact the accuracy of the vehicle information 113 provided from the vehicle information service 20. Based on the evaluation, the ORDC 116 can modify the operational range 115 from the vehicle information source 20.

In some examples, the ORDC 116 also implements logic to determine the operational range 115, based on the vehicle information 113 obtained from the vehicle information service 20, as well as determination of one or more factors that can affect the operational range of the vehicle. In examples, the ORDC 116 can access a service provider profile store 114 to retrieve profile information that may impact the operational range 115, such as historical information that indicates an impact the driver's driving style or the vehicle's condition (e.g., tires) has on the operational range provided by the vehicle information service 20. As an addition or variation, the ORDC 116 can also access a weather service to determine a weather condition or forecast affecting driving conditions.

In some examples, the ORDC 116 can also access the profile store 114 to determine a service provider's preferred restoration level 111, representing the charge level where the service provider prefers to recharge his vehicle. The preferred restoration level 111 can represent an operational range value that can also be reflected as a charge level of the vehicle's battery (e.g., 20% charge level), a fuel level of the vehicle's fuel tank (e.g., quarter tank reading), a remaining capacity of a battery fuel cell, or a combination thereof for hybrid and multi-source vehicles. For example, the preferred restoration level 111 for a service provider's EV may correspond to 50 miles, which can also reflect a charge level 20%. In some examples, the service provider can specify a preferred restoration level 111. For example, the service provider can specify the preferred restore point or trigger level 111 through interaction with the service application. In some variations, the network system 100 can include a driver profiler 122 that records session vehicle data for the service provider. The session vehicle data can record the operational range of the vehicle during prior sessions when the service provider sought to charge their vehicle.

Based on the preferred restoration level 111, the ORDC 116 can also determine a preferred remaining range 119 for the vehicle. The preferred remaining range 119 can be estimated as a difference between the current operational range 115 of the vehicle and the operational range corresponding to the preferred restoration level 111 of the service provider. The ORDC 116 can associate the preferred remaining range 119 with the record 125 of the service provider. Further, the ORDC 116 can repeatedly, or continuously update the service provider's record 125 with the preferred remaining range 119.

### Transport Request Determinations

The requester device interface 112 receives transport requests 101 from requester devices 102. The transport requests 101 can specify service parameters that include a service start location and a service end location. The request handler 120 creates a service request record 103 for a newly received transport request with the service data store 130. The service request record 103 may include an identifier of the requester, a status of the transport request (e.g., open, matched, etc.), and the service parameters. The request handler 120 can also communicate with the requester device 102, provider device 104 or other sources to update the transport request record for status and other information. Further, the request handler 120 can initiate other processes represented by transport request analysis component (“TRAC”) 132, to analyze transport requests 101.

In examples, the network system 100 includes geographic information stores, and/or programmatic interfaces to external services that provide geographic information (collectively represented by “geographic information resource”). In examples, the geographic information resources 135 include data stores of information related to specific locations, including points-of-interests such as EV charging stations. In some variations, the geographic information resources 135 includes programmatic interface(s) to external geographic information services, such as mapping services, third-party charging maps and other geographic-specific information. As described with various examples, the geographic information resources 135 can represent one or more types of information resources that can be queried and/or updated by processes of the network system 100 independently of one another. The geographic information resources 135 can include, for example, mapping services that can identify travel distances, as well as data stores that identify recharging locations, such as locations of charging stations, hydrogen fueling stations, diesel stations, gasoline stations, etc. As described with some examples, the geographic information resources 135 can also record information generated by processes of the network system 100 relating to specific recharging locations.

The TRAC 132 can include or otherwise interface with the geographic information resources 135 to determine a travel distance for a transport request 101 based on the service parameters of the transport request (e.g., service start and end locations). When the transport request 101 is received, the TRAC 132 can query the geographic information resources 135 to determine the travel distance for the transport request, and to associate the travel distance with the service request record 103 of the transport request 101.

As an addition or variation the TRAC 132 can also query the geographic information resource 135 to determine one or more recharging stations that are within a threshold proximity to the service end locations of individual transport requests. For a given transport request, the TRAC 132 can query the geographic information resource(s) 135 to determine recharging stations of one or more types (e.g., gasoline, diesel, hydrogen, electrical, etc.) that are within a threshold proximity, and/or nearest to the service end location of the transport request. The TRAC 132 can also query the geographic information resource(s) 135 to identify additional information. For example, the TRAC 132 can query the geographic information resource 135 to determine the capacity, charging output, and other information (e.g., amenities) associated with a vehicle charging station. Further, the TRAC 132 can calculate, for individual transport requests, a distance of travel to charge after completion of the transport request (after-trip charging distance 133), measured from the service end location to one or more charging station(s). The TRAC 132 can also calculate the trip distance 131 for each transport request, measured from service start to service end locations. In this way, the TRAC 132 can associate each transport request 101 with (i) the location(s) of the individual charging stations that are identified based on the service end location of the transport request, (ii) the trip distance 131, and (iii) the after-trip charging distance 133.

In some examples, the location(s) of individual charging stations, the trip distance 131 and/or the after-trip charging distance 133 are determined and associated with the service request record 103 in advance of, or asynchronously to the matching process. In variations, the TRAC 132 determines the location(s) of individual charging stations, the trip distance 131 and/or the after-trip charging distance 133 as part of the matching process.

### Matching Process

The matching engine 140 implements operations to match open transport requests with available service providers. Depending on the type of transport (e.g., singular versus pooled transport), the available service provider can have an empty vehicle, or the vehicle can be occupied with capacity to accommodate another rider. In variations, an available service provider can correspond to a service provider that is nearing an end to fulfilling an existing transport request 101 (e.g., within a threshold distance of the destination of the existing transport request). In examples, the factors that are used for matching an available service provider to an open transport request can include, for example, (i) the proximity of the service provider to a service start location, (ii) the type of vehicle or service provided by the service provider, (iii) the proximity of other available service providers to the service start location, (iv) the type of vehicle being provided by the service provider, and (v) the operational range of the vehicle. Additionally, in examples, the matching factors can include the proximity and availability of charging stations to a location of the service provider and/or to a destination location of the service request. The factors for matching service providers to transport requests can also include additional or alternative criteria, such as preferences of the service provider as to the distance of travel and/or service end location.

The individual matching factors can include determinative criteria for a particular match (e.g., candidate service providers have to be within threshold distance from pickup location). For example, as described in more detail, if the operational range of a service provider's vehicle is less than the distance required for a service request to be fulfilled, then the service provider can be filtered out of, or otherwise excluded as a candidate for the match.

In examples, once a transport request is matched to a service provider, the service provider is provided an invitation to accept or reject the transport request. The invitation can be in the form of an interactive notification, provided through the service application 118 that executes on the provider device 104 while the provider is utilizing the on-demand service. The invitation may be provided exclusively to the service provider for a given time interval, meaning the matched service provider can elect to accept or decline the invitation. In variations, a transport request can be matched to multiple service providers, each of whom receive an invitation to accept or decline the invitation. In the latter case, the matching engine 140 can make an additional selection amongst those service providers that accept the transport request in a given time interval based on one or more of the matching factors.

In some examples, the matching engine 140 implements a matching process for each transport request 101, where the matching engine identifies a candidate set of service providers for each transport request, then selects the service provider from the candidate set. If the selected service provider declines the invitation, the matching engine 140 can select a different service provider from the candidate set. Alternatively, the matching engine 140 can re-determine the candidate set again, and then select a different service provider for the transport request.

Examples recognize that with on-demand transport arrangement services, a mismatch of service provider to a transport request can hinder the efficiency of the on-demand service. Service providers can unnecessarily decline transport requests when they are low on charge because they are uncertain that as to whether their vehicle has sufficient operational range to reach a recharge station after the transport request is completed. When a transport provider declines an invitation, for example, the network system has to perform additional operations to find a new transport provider, meaning more work is performed for the transport request. Further, if the service provider charges their vehicle in the course of fulfilling the transport request, then the requester experiences a delay in arriving at their desired service end location. The delay caused by fueling or charging alternative fuel cars may also be more significant, as alternative fuel cars can have fewer stations available, making navigation to the station more time consuming. Further, alternative fuel vehicles can sometimes take longer to charge/refuel than conventional petroleum vehicles. For example, EVs generally take longer to recharge than petroleum vehicles, and the charging speed for the vehicle mat vary greatly based on factors such as make, model and year of the vehicle, the equipment used by the charging station, the number of vehicles being charged at the station, the condition of the power grid, and/or other factors.

Accordingly, in examples, the matching engine 140 can implement a matching process that accounts for the operational range of the service provider's vehicle, to avoid instances where the matched service provider will decline an invitation to insufficient range, or trips where the service provider charges (or fuels) their vehicle while fulfilling the transport request. In examples, the matching engine 140 makes a determination as to whether an available service provider has sufficient range to avoid recharging when fulfilling the transport request. In making the determination, the matching engine 140 identifies a requisite distance of travel 137 for the service provider, where the requisite distance of travel 137 is based on a current location of the service provider, the service start location, the service end location, and one or more charging stations in proximity to the service end location. For example, the requisite distance of travel 137 for a given service provider can be based on (i) a distance of travel between the current location of the service provider and the service start location, (ii) a distance of travel from the service start location to the service end location (or trip distance 131), and (iii) a distance of travel from the service end location to a location where the service provider can charge their vehicle (or “after-trip charging distance 133”). In some examples, the requisite distance of travel 137 can correspond to the sum of the aforementioned distances, with addition of a margin (e.g., 0 to 50 miles). The requisite distance of travel 137 can be determined in real-time, by for example, the matching engine 140 invoking the TRAC 132 to calculate the applicable distances of travel and/or the service/recharge locations. As an addition or variation, some or all of the information used for determining the requisite distance of travel 137 is predetermined by the TRAC 132 and associated with the service request record 103.

Further, in performing the matching operations for the service provider, the matching engine 140 compares the operational range 115 of the service provider's vehicle to the requisite distance of travel 137 (calculated for the service provider to fulfill the transport request and charge after completion of the transport request). For a given match determination, if the operational range 115 of the service provider's vehicle is greater than the requisite distance of travel 137 of the transport request, then the service provider may be deemed suitable for the transport request, and the match can be performed. Otherwise, the service provider may be deemed unsuitable for the transport request for insufficient operational range 115. In such cases, the service provider may be matched to transport requests that have a lesser requisite distance of travel 137.

Further, some examples recognize that individual service providers may a tendency or preference to recharge their vehicle at a preferred restoration level 111. To accommodate service providers with such a preference, the matching engine 140 can implement matching by comparing the preferred operational range 119 of the service provider's vehicle to the requisite distance of travel 137 (calculated for the service provider to fulfill the transport request and charge (or refuel) after completion of the transport request). If the preferred operational range 119 of the service provider's vehicle is greater than the requisite distance of travel 137, then the service provider may be deemed suitable for the transport request, and the match can be performed.

In some variations, the matching engine 140 determines a candidate set of service providers for individual transport requests. If the transport request is deemed unsuitable for the service provider due to lack of operational range, the matching engine 140 excludes the service provider from the candidate set. The matching engine 140 performs the operations to match the transport request 101 with the candidate set, without consideration of service providers that are excluded for lack of operational range.

Still further, the matching engine 140 can match a service provider to a service request based on an objective of ensuring the service provider is within a threshold distance of a charging station when the service request is completed. For example, the matching engine 140 can match a service provider to a service request based on a determination that a destination of a transport request is within a threshold distance of a charging station. In such examples, the threshold distance can be determined based at least in part on the operating range of the service vehicle.

Additionally, the matching factors can include EV factors that weigh in favor or against a particular match. For example, if a user prefers an EV, then the matching engine can weight EV vehicles in the matching process so that EV vehicles are more likely be matched to the service request.

Still further, the matching engine 140 can implement optimizations for service providers that operate EVs. For example, the matching engine 140 can implement a matching process where the matching engine 140 identifies candidate service providers that operate EVs which can fulfill the service request, but which will need to charge their vehicle upon fulfilling the service request. As an addition or variation, the matching process can identify service providers that operate EVs and who are scheduled to charge their vehicle during a time interval that coincides or follows the time when the matched service request is expected to be completed. In such scenarios, the matching engine 140 can determine whether a destination for a service request is within a threshold distance of a suitable or preferred charging station for the service provider. If the destination location for the service request is within the threshold distance to the suitable or preferred charging station for a service provider operating an EV, then the matching process can prioritize, or otherwise weigh in favor of matching the EV service provider to that service request. In this way, the matching engine 140 can implement an optimization where the matching process maximizes the use of EVs and/or reduces the amount of time required for EVs to be recharged while providing transport services.

### Historical Information Gathering and Profile Determination

In examples, one or more historical data store(s) 128 can be created and maintained based at least in part on data initially recorded with the service data store 130. The historical information 129A can be specific to geographic regions, sub-regions, and time intervals (e.g., hours of a day). By way of example, the historical information can include information about prior transport requests (e.g., when transport request was received, matched and fulfilled), service locations of transport requests, service requesters and providers that were utilizing the on-demand service, service providers that were available, routes and route segments used by service provider, time of travel across route segments, and other information.

As an addition or variation, the historical data store(s) 128 can include historical information 129B that is specific to individual service providers. The historical information 129B can be created and maintained by one or more processes represented by monitoring component 134. The monitoring component 134 can query the driver devices 104 (via the driver device interface 110), the service data store 130 and/or the vehicle information service(s) 20 for information about the service provider and/or service provider vehicle. The historical information 129B can indicate, for example, sub-regions that the service provider typically operates in. Additionally, the historical information 129B can indicate the charge level of the service provider's vehicle when the service providers seeks to recharge their vehicles. Further, the historical information 129B can indicate the operational range of the vehicles used by individual service providers, when they seek to charge their vehicles, the time the service provider required to charge, and other information related to charging the service provider's vehicle. In some examples, when a service provider stops to charge his vehicle, the service provider may change his or her status with the on-demand service to “pause”. The change in status can be reflected in the service data store 130. When the status of the service provider is paused, the network system 100 does not match transport requests to the service provider.

The processes of monitoring component 134 can further analyze and determine preferences and/or tendencies of the service provider with respect to operating the vehicle and providing transport services. The monitoring component 134 can access historical information 129B about the service provider to determine, for example, sub-region where the service provider typically operates and/or typical time intervals during which the service provider is available to the on-demand service. Further, based on historical information 129B, the monitoring component 134 can estimate the amount of charge that the service provider's vehicle consumes during a time interval in which the service provider is available to the on-demand service. In examples, the monitoring component 134 can correlate and refine the estimate of consumed charge by the service provider based on the number service requests the service provider fulfills and/or the distance the service provider drives. The monitoring component 134 can also track the current operational range 115 of individual service provider vehicles to determine whether the respective operational range tracks what is expected by a model driver and/or vehicle. For each service provider, the monitoring component 134 can generate profile information 121 that models the service provider's time interval, charge consumption (e.g., based on driving habits, routes traveled, charging preferences, etc.), geographic information and/or other information determined through historical analysis of the service provider's sessions with the on-demand service.

In some examples, the monitoring component 134 can monitor the state of the service provider to determine when the service provider is paused. As an addition or variation, the monitoring component 134 can check the operational range 115 of the service provider's vehicle (as may be recorded in the service data store 130) to determine when the operational range increases by an amount greater than a threshold value, so as to indicate charging. The monitoring component 134 can correlate the time when the service provider charged their vehicle to the vehicle's charge level. Thus, based on the correlation, the monitoring component 134 can identify a preference or tendency of the service provider to charge a vehicle when the charge level of the vehicle is at a particular level corresponding to the preferred restoration level 111. Further, the monitoring component 134 can also determine a duration of time for the service provider to charge their vehicle (e.g., based on the duration of the pause state for the service provider).

The monitoring component 134 can also identify a preferred charging station for the service provider, based on, for example, the frequency the service provider uses the charging station and/or the travel distance that the service provider travels. Still further, the monitoring component 134 can determine other information, such as amenities the service provider prefers charging stations. In this way, the monitoring component 134 can determine a set of preferences, tendencies or characteristics of the service provider (or service provider vehicle) with respect to charging: (i) the preferred restoration level 111 (when the service provider seeks to recharge); (ii) the duration of time it takes for service providers to charge their vehicle; (iii) the preferred charging station of the service provider; and/or (iv) amenities and other characteristic information about the charging station which the service provider prefers. The preferences and tendencies can be stored as profile information in a profile information store 114.

As described with examples, the service provider can also be prompted to take certain actions. For example, the EV guide component 144 can generate a recommendation to have a service provider schedule the charging of their EV at a particular time. Once the service provider schedules their charging time, the monitoring component 134 can provide reminders and other notifications to the service provider, to prompt the service provider to charge their vehicle as recommended. The monitoring component 134 can also monitor the location and activity of the service provider during the recommended charge time to detect if the service provider misses the charge time. If the service provider is detected to miss their charge time, the monitoring component can trigger the EV guide component 144 to reinitiate a process to determine a new recommended charging time.

### Forecasting

The network system 100 can further include one or more processes (represented by forecasting component 138) to forecast demand for individual service providers. For a given region or sub-region and time interval, the forecasting component 138 can determine the demand for specific service providers based on the overall demand on the on-demand services for transport services and/or the number of service providers. The forecasting component 138 can use historical information 129A to forecast demand and/or availability of service providers over sub-intervals (e.g., every hour, half-hour, quarter-hour, etc.). In examples, the forecasting component 138 includes processes to train one or more models using the historical information 129A, and further to deploy the models to forecast demand and/or availability for individual service providers, as well as related aspects thereof, over sub-intervals of a given time interval. The training of the models can be accomplished by processes of the forecasting component 138 that monitor the service data store 130 and compare the results of the forecast models with the actual outcomes as determined from the service data store 130. The forecasting component 138 forecasts the activity level of the service provider at one or more sub-intervals, where the activity level corresponds to the number of transport requests the service provider receives or fulfills, and/or the amount of fates the service provider earns. The determinations 139 of the forecast component 138 can include (i) identification of sub-interval(s) in a given time interval (e.g., 8, 12 or 24 hour span), where service providers of a given geographic region are likely to spend the most (or least time) fulfilling transport requests; (ii) identification of sub-interval(s) in a given time interval where service providers of a given geographic region are likely to fulfill the greatest (or least) number of transport requests; (iii) identification of sub-interval(s) in a given time interval where service providers of a given geographic region are likely to earn the most (or least) amount of fares; and/or (iv) a probability distribution of a number of fares a service provider is expected to receive in individual sub-intervals.

### Monitoring of Use of Charging Stations

The network system 100 can include program interfaces, data stores and other resources for communicating with electric charging networks (“ECN component 148”) to receive charging network information 149. The charging network information 149 can identify (i) the locations of the charging stations of the network, (ii) the category of the charging station (e.g., high capacity or Level 1 versus moderate charging capacity or Level 2), (iii) identify the number of available stalls at a charging station of the network, (iv) the power output available with the charging station (e.g., maximum power output), (v) the rates charged to operators for charging their vehicles at the station, and (vi) other information (e.g., amenities offered at the charging station). The charging rate information may be in accordance with a schedule, such that the charging rates at individual stations may vary based on time of day or conditions that may be present.

In examples, the ECN component 148 can also include a charging station profile logic to predict the availability of stalls, the maximum power output and/or the charging rate of individual EV charging stations. The ECN component 148 can collect the charging network information 149 for individual charging stations, record the number of available stalls, power output, and/or charging rate (as well as other information), and use the collected data to train one or more predictive models and/or develop rules or other logic. In this way, the ECN component 148 can predict the availability of stalls in relation to factors such as time and day, charging rate and other considerations relating to a demand for charging stations.

### Ev Guide Component

In examples, the network system 100 executes processes, represented by EV guide component 144, to provide data to generate interfaces and provide EV-relevant information (“EV information 145”) to the service provider's device 104. In some examples, the EV information 145 can cause the service application 118 executing on the provider device 104 to generate interactive interfaces and notifications for facilitating the service provider in, for example, planning charging times for the service provider's EV.

Further, in examples, the EV guide component 144 generates guidance content for a service provider of an EV, where the guidance content includes (i) recommendations for the service provider to charge their EV at a particular time and/or location, in order to optimize an objective (e.g., maximize earning for service provider, maximize availability of transport vehicles in given region during peak times, etc.), and (ii) charging considerations, reflecting information about charging that the service provider may want to know to facilitate service provider decision making. The charging considerations can include rational and justifications for a recommendation (e.g., reason to charge at a particular time or location).

The recommendations can specify an action the service provider should take which relate to charging the EV, including actions specifying when and/or where the EV should be charged. The recommendations can include corresponding charging considerations that provide rational or justification for the recommended action. The recommendations can include graphic and/or textual content, communicated to the service provider in form of notifications or as a display screen of a user interface of a service application.

The charging considerations can include information items provided to the user in context of a user action. For example, information items can be provided to users through notifications and/or application interfaces of the service application.

In formulating guidance content, the EV guide component 144 can process EV information 145 to identify types and locations of charging stations. The EV guide component 145 can reference location and type of charging stations to regions within a threshold vicinity of a destination location for a transport request. In examples, the EV guide component 144 can generate a charging consideration for the destination location of a service request, such as “Nearest [fast] charging station is more than 10 miles from the destination of this service request.” The charging consideration can further be combined with a particular context. For example, the EV guidance component 144 can scan the records of newly received transport request, as maintained by the service data store 130, and augment the record with charging considerations for EV vehicles, such that when an invitation for the transport request is transmitted, the invitation integrates the charging consideration. Alternatively, the EV guidance component 144 can communicate the charging consideration to individual service provider devices 104 via the provider device interface 104. For example, the charging consideration can be integrated with an invitation that is transmitted to a service provider device 104, or to a candidate number of service provider devices.

The EV guide component 144 can further reference information about available charging stations near the destination location with specific information about the service provider's EV (e.g., current range, type of charging station most suitable for service provider's EV). In this way, the recommendations and/or charging considerations can be specific to individual service provider's, by, for example, taking into account an EV charging related condition of the service provider. By way of example, before an invitation for a service request is communicated to the service provider, the EV guide component 144 can integrate service provider-specific charging consideration (or recommendation) with the invitation transmitted to the service provider device 104.

As further described, the EV guidance component 144 can also determine predictive information relating to the cost of charging stations for an upcoming time interval (which can vary based on demand, grid conditions, etc.), where the predictive information is determined from current and historical EV information 145, as well as information determined from monitoring EV usage by service providers. The EV guidance component 144 can also determine predictive information relating to the demand for transport vehicles (including EVs of individual service providers) based at least in part on historical information about the transport service in the given region. As described in more detail, the EV guide component 144 can use predictive determinations to generate recommendations for service provider that further an objective of the service provider (e.g., net earnings) or transport service (e.g., maximize availability of service providers during peak times).

According to some examples, the EV guide component 144 includes processes to facilitate the service provider in scheduling or otherwise planning a time to charge his or her vehicle. In an aspect, when a service provider initially becomes available to the on-demand service, the EV guide component 144 can cause the service application 118 to generate one or more interfaces or notifications to prompt the service provider to provide input that indicates an expected or planned time interval of the service provider's availability. The time interval can be referenced by input that indicates the provider's intended sign-off time and/or the amount of time between when the service provider initially signs on and signs off. For example, the prompt can be in the form of an interface that asks the service provider “until what time do you plan to drive today?”, with an input feature that enables the service provider input a time. Based on the service provider's response, the EV guide component 144 determines the upcoming time interval, representing the duration in which the service provider is expected to be available for the on-demand service. The determined time interval for the service provider can correspond to a continuous set of hours, starting from when the service provider goes online. Alternatively, the service provider can specify periods during the upcoming time interval when the service provider intends to be offline, on pause or otherwise unavailable.

In variations, the EV guide component 144 can determine the duration of the upcoming time interval for individual service providers based on a setting, by default, and/or through profile information. For example, service providers can be assumed to be available for 4, 6 or 8 hour time intervals based on a provider preference, where the provider preference is determined by provider input or learned through monitoring of the service provider's activities. In the latter case, the EV guide component 144 can implement processes that record the duration of the service provider's availability and/or the times when the service provider typically stops working through the on-demand service. Based on the recorded information, the EV guide component 144 can develop models or logic to predict a duration of the service provider's availability once the service provider goes online.

The EV guide component 144 can also prompt the service provider to provide information that indicates a service provider's intent or preference to charge their vehicle after they go online. The input can indicate whether the service provider intends to charge their vehicle, the time the service provider intends to charge, and the current charge state of their vehicle. As an addition or variation, the EV guide component 144 can determine the charge state of the service provider's vehicle based on the current operational range 115 and/or other vehicle service information 117. The current operational range 115 of the service provider can be retrieved from the active service data store 130 and/or the vehicle information service 20. Based on the service provider's profile information 121 and the current operational range 115 of the service provider's vehicle, the EV guide component 144 can predict the service provider's operational range in one or more upcoming sub-time intervals. For example, the EV guide component 144 can estimate amount of charge the service provider will consume at discrete times over the course of the upcoming time interval. The charge consumption can be determined based on, for example, historical information 129B associated with the service provider, typical charge consumption values associated with service providers of a similar category, and/or the forecasted activity level for the service provider (e.g., number of transport requests expected for the service provider, the amount of driving the service provider is expected to perform, etc.) during the upcoming time interval. Based on the current operational range 115 and the expected consumption level of charge, the EV guide component 144 can estimate a time during the upcoming time interval when the service provider will be at a minimum threshold operational range level. In the context of an EV, for example, the minimum threshold operational range level can correspond to a predetermined battery charge level (e.g., 0-20% charge), a charge level determined to allow for the service provider to reach a charge station, or the preferred restoration level 111 for the service provider.

For the upcoming time interval, the EV guide component 144 can determine scheduling information 147 that identifies times when the service provider can or should charge their vehicle. As described with examples, the EV guide component 144 can determine the scheduling information 147 based on factors such as (i) the duration of time when the service provider intends to be online or available to the on-demand transport, (ii) the current charge level (or operational range of the vehicle), and/or (iii) the service provider's intent to charge their vehicle during the upcoming time interval. Additionally, the scheduling information 147 can be based on the determinations 139 of the forecast component 138. As described in greater detail, the scheduling information 147 can determine (i) one or more sub-intervals that are recommended for the service provider to charge their vehicle, (ii) one or more sub-intervals that are recommended for the service provider to be available for transport services and not charge their vehicle, and/or (iii) a ranking, score or other metric that indicates the relative rank of the sub-interval for charging (or not charging) relative to other sub-intervals.

In determining the scheduling information 147, the EV guide component 144 can utilize the determinations 139 of the forecast component 138 to determine a forecasted activity level for individual service providers at one or more sub-intervals of the upcoming time interval. As described with other examples, the forecast activity level for a given sub-interval can include the number of transport requests the service provider can expect to receive and/or the amount of fares the service provider can expect to earn.

Accordingly, in examples, the EV guide component 144 generates scheduling information 147 that includes a recommendation for the service provider to charge (or go on pause to charge) during one or more upcoming sub-intervals. As an alternative or variation, the EV guide component 144 can generate a recommendation for the service provider to not recharge (or stay online to provide transport services) during one or more upcoming sub-intervals. The EV guide component 144 can generate the recommendations based on the forecast activity level for the service provider at different upcoming sub-intervals, as well as the predicted time when the service provider's vehicle is expected to reach the minimum threshold operational range level. To illustrate, the EV guide component 144 may determine that the service provider's vehicle is likely to fully deplete of charge by 8 PM, the forecasted activity level for the service provider is expected to be greatest between 6 PM-8 PM, and slowest between 3-4 PM. In such a scenario, the EV guide component 144 can generate the scheduling information 147 to include a recommendation for the service provider to charge their vehicle between 3-4 PM, such that the service provider is on pause when the forecast predicts the lowest activity level for the service provider.

In some examples, the EV guide component 144 generates a recommendation that identifies an upcoming time interval (e.g., 15 or 20 minute slot) of the service provider's current session time during which the service should charge his EV. The recommendation can be generated to optimize an objective of the service provider. For example, the EV guide component 144 can optimize for an objective in which a service provider driving an EV earns the most net income, based on earnings through fares less cost for service provider to recharge his vehicle. The EV guide component 144 can communicate with map resources to determine, for example, the published cost for charging stations which the service provider may utilize (e.g., based on the preference of the service provider for a particular geographic sub-region). The charging cost for a charging station can vary depending on, for example, the expected or actual demand for chargers at the station, as well as the cost for drawing power from the electrical grid. The EV guide component 144 can also predict, based on historical data, the charging cost for the service provider's vehicle over the course of the service provider's session time. The EV guide component 144 can optimize for net income of the service provider by determining a sub-interval when the service provider is expected to earn the most net income. Thus, in the scenario described above, charging during the sub-interval of 3-4 PM may enable the service provider to maximize his fares, but if the charging cost is expected to drop between 4-5 PM, then the EV guide component 144 may generate a recommendation for the service provider to charge during 4-5 PM, based on a determination that charging during 4-5 PM would optimize the net income the service provider could earn.

As an addition or alternative, the EV guide component can generate a recommendation for the service provider to charge their vehicle based on an objective that includes minimizing a cost of charging the service provider's vehicle. The cost of charging can be based on a cost to charge a vehicle at a charging station, which can be based on the charging rate of the charging station. The EV guide component 144 can determine and apply charging rates from the ECN component 148. Further, in examples, the cost of charging their vehicle can also be based on an expected down-time of the service provider vehicle. The expected down-time can be based on, for example, an amount of time the service provider will need to charge their vehicle. The EV guide component 144 can determine the expected down-time based on one or more of (i) a current or predicted availability of stalls (e.g., number of stalls that are most likely to be available at a given time) at individual charging stations, (ii) an expected amount of time for the service provider to charge their vehicle, (iii) an expected amount of time for the service provider to travel to the charging station, and/or (iv) one or more tendencies (e.g., charging behavior) of the service provider. The EV component 144 can predict the availability of stalls, for example, using the charging station profiles and logic. The expected amount of time for the service provider to charge their vehicle can be determined from, for example, charging times associated with charging stations, charging times of service providers (e.g., determined from monitoring charging or pause times of service providers), the charging speed of the charging station, and/or charging capabilities of the service provider's vehicle. The expected amount of time for the service provider to travel to the charging station can be based on the amount of traffic or congestion at or near individual charging stations. Additionally, the tendencies of the service provider for charging can be based on monitoring and developing a charging profile of the service provider (e.g., based on a duration of service provider's pause time when charging).

In examples, the EV guide component 144 can generate the scheduling information 147 when the service provider initially becomes available for an upcoming time interval. For example, at the start of a session, the EV guide component 144 can transmit the scheduling information 147 to the provider device 104 via the provider device interface 110. In other examples, the EV guide component 144 can transmit scheduling information 147 to the service provider in response to a request from the service provider.

Still further, in some examples, the EV guide component 144 can transmit the scheduling information to the service provider in response to a detected event, such as the service provider's vehicle being determined to be low in operational range. As another example, the EV guide component 144 can transmit scheduling information 147 as an update to a previous transmission in response to the service provider not charging the service vehicle at a planned or suggested time interval.

In examples, the EV guide component 144 can also generate EV information 145 that provides ongoing information relating to the activity that the service provider can provide based on the charge level of their vehicle. The amount of activity can be represented by metrics such as (i) a count or number of service requests that the service provider can expect to receive or fulfill before the service provider has to charge their vehicle, and/or (ii) an amount of fares the service provider can collect before having to charge their vehicle. The EV guide component 144 can determine the metrics based on, for example, the current and predicted charge level (or operational range) of the service vehicle and/or the forecast determinations 139 of the forecast component 138.

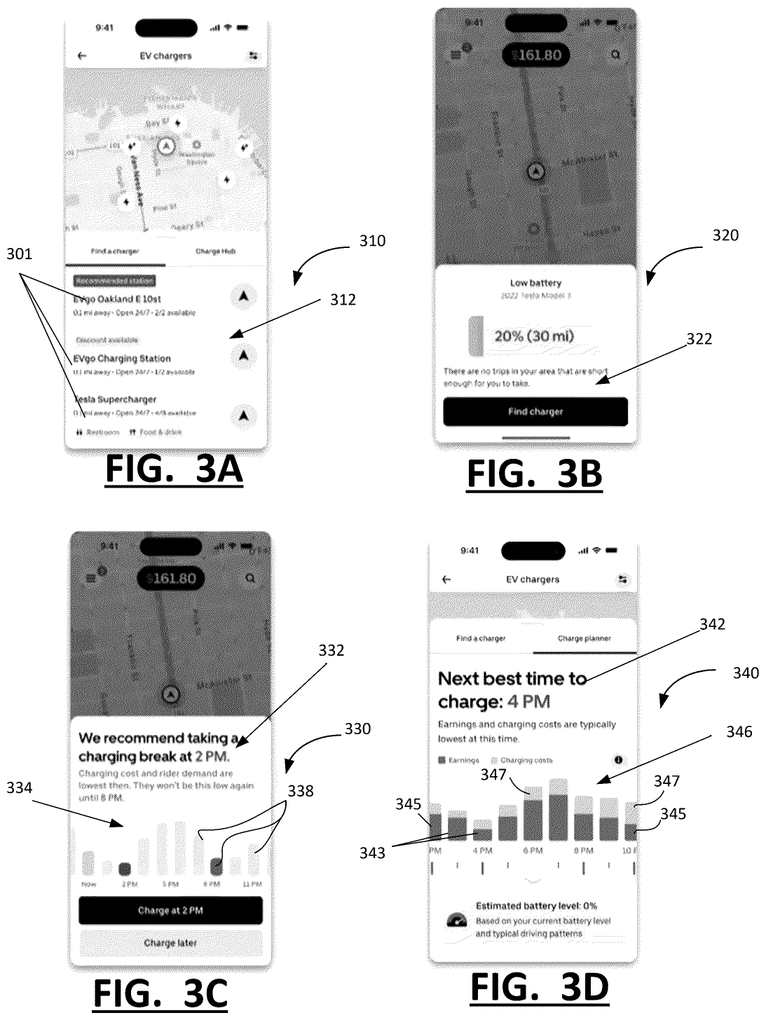

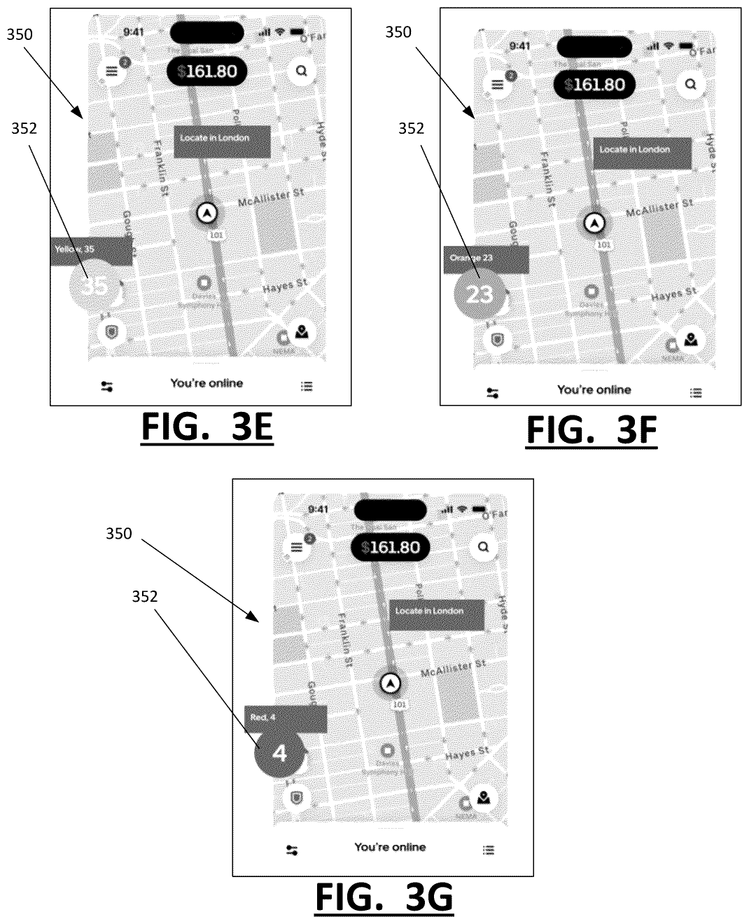

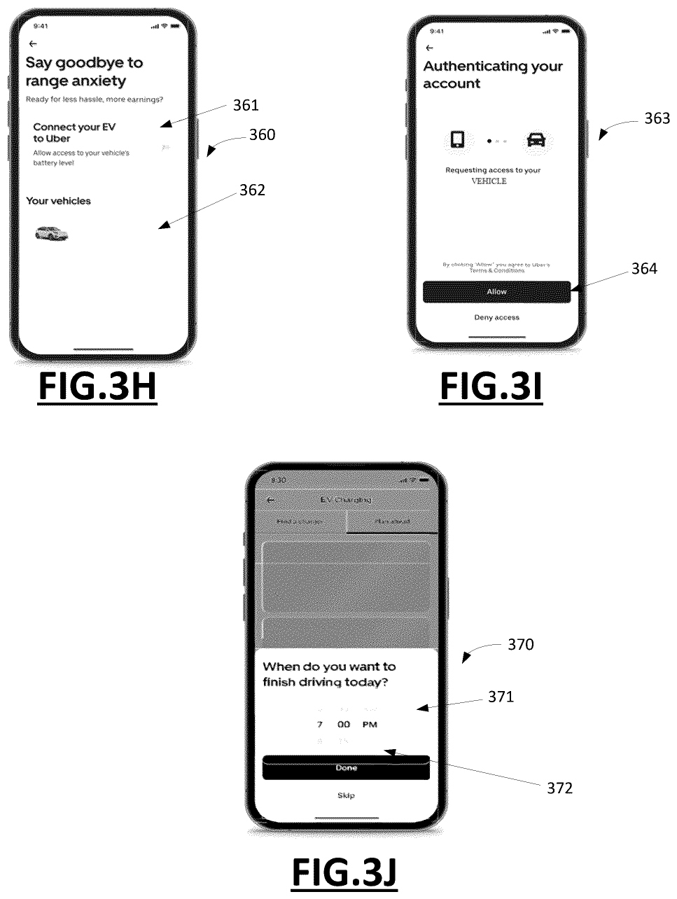

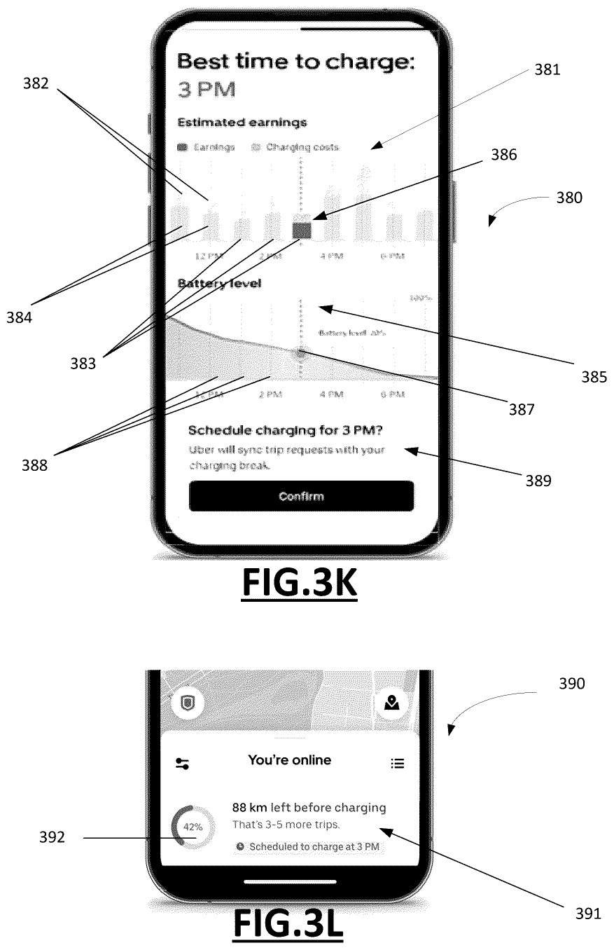

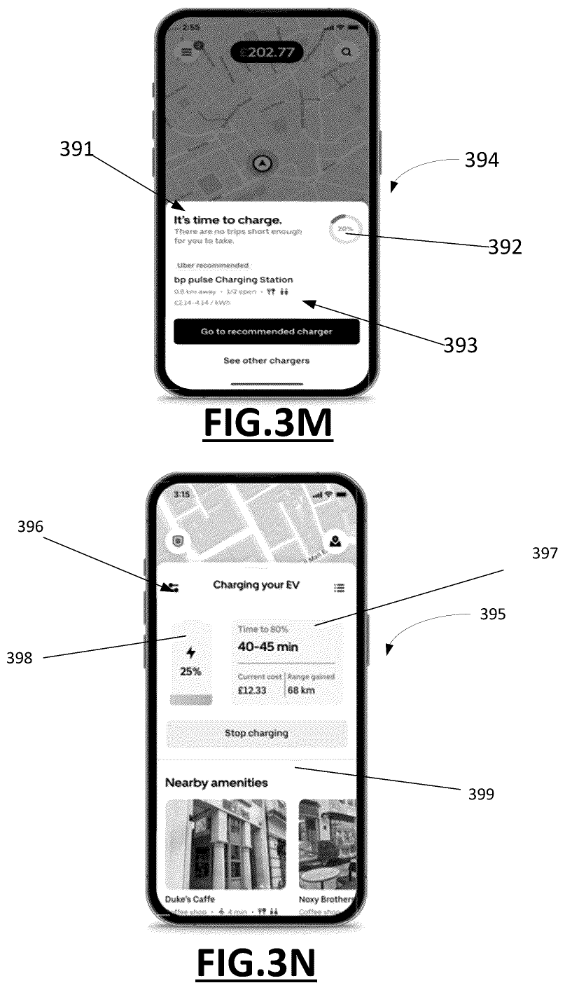

In some examples, when the service provider is fulfilling a transport request and is nearing the destination, the EV guide component 144 can prompt the user to charge their vehicle. In variations, the EV component 144 can prompt the service provider in response to a determination that the operational range of the service provider's vehicle is below a threshold level. Still further, the determination can be based on an estimated number of service requests that the service provider can fulfill (e.g., number of trips) before running out of charge. For example, the EV guide component 144 can determine a metric 253 (see FIG. 3E through FIG. 3G) that reflects a number of trips the service provider is expected to be able to complete before having to charge their vehicle. Once the metric 352 drops to a given threshold (e.g., no trips left, less than 5 trips let, etc.), the EV guide component 144 can prompt the user to charge their vehicle.

Further, in prompting the service provider, the EV guide component 144 can generate a recommendation that selects a charging station to recommend to the service provider. The recommended charging station can correspond to a charging station that is selected from a candidate group, where each charging station of the candidate group are otherwise suitable charges within a given area or threshold distance of the service provider. The determination of which charging station to recommend can be based on factors such as availability (e.g., number of open stalls at each nearby charging station), charging speed (e.g., power output of charging station, accessibility of stalls, etc.), charging costs (e.g., based on charging network) and/or amenities. The EV guide component 144 can determine the information used to select a recommended charging station using, for example, the ECN component 148.

Accordingly, as described with examples, the EV guide component 144 can generate recommendations that indicate when (e.g., upcoming time slot) and where (e.g., which charging station) the service provider should charge their vehicle. The recommendations can be generated based on one or more objectives, such as to maximize earnings for the service provider and/or reduce down time of the service provider (e.g., resulting from the service provider charging their vehicle) at peak times where demand for the service provider may be at its highest.

Still further, in some examples, the EV guide component 144 can receive input to schedule charging of the service provider's vehicle. For example, the service provider can accept a recommendation to charge their vehicle at a particular time and/or location. In response, the provider device interface 110 can update the service provider's record or profile information to reflect that the service provider has a scheduled charging time in an upcoming time interval. As described, the monitoring component 134 can track the service provider to detect when the service provider is about to miss or has missed their charging time. In the event the service provider misses their scheduled charging time, the monitoring component 134 can trigger the EV guide component 144 to re-perform the recommendation and provide a new recommended time interval for charging.

Additionally, in examples, the EV guide component 144 can reserve a charger for the service provider. The EV guide component 144 can schedule and/or reserve a stall at a charging station on behalf of the service provider based on input provided by the service provider through the service application. As an addition or variation, the EV guide component 144 can schedule and/or reserve a stall for the service provider to charge their vehicle based on the occurrence of an event, such as the service provider reaching a threshold charge level or operational range, or the service provider completing (or nearing completion) of a trip where their charge level or operational range is below a given threshold.

The EV guide component 144 can communicate a reservation through, for example, an electric charging network, to reserve a stall at a particular location or area (e.g., close to the location of the service provider, at the destination of the service provider's current trip, etc.). Once the reservation is made, the EV component 144 can transmit data to the provider device 104 to confirm the reserved stall. The EV guide component 144 can further generate prompts, or trigger the service application to trigger prompts to guide the service provider to the reserved stall.

### Methodology

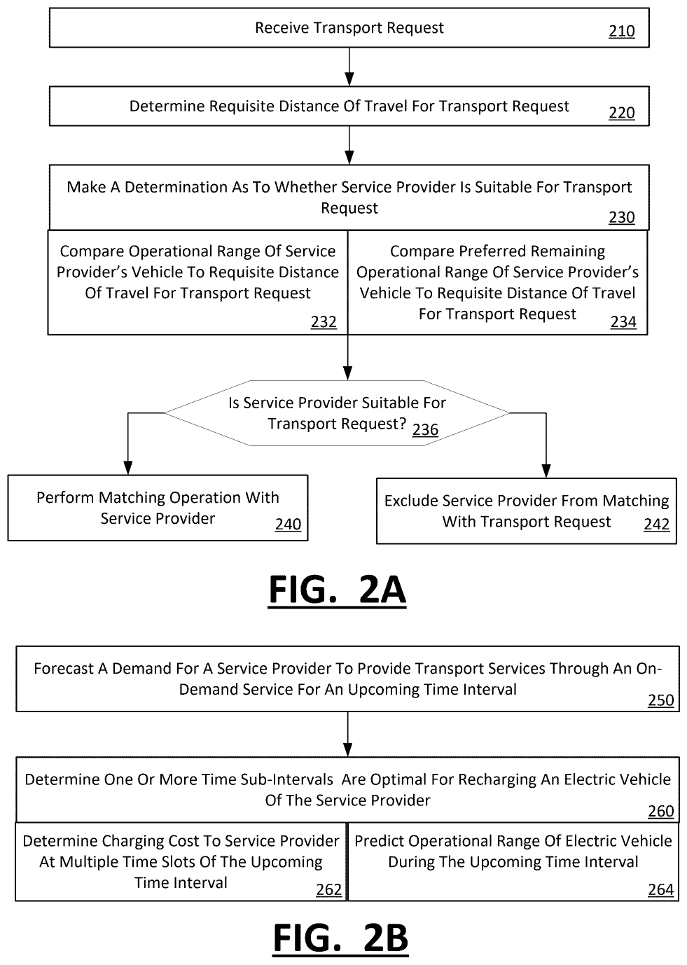

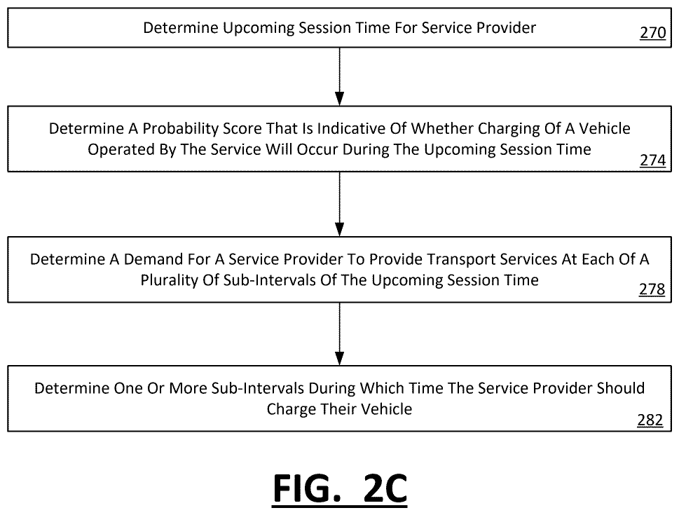

FIG. 2A illustrates an example method for determining whether a service provider is suitable for matching to a transport request, according to one or more embodiments. FIG. 2B illustrates an example method for providing a recommendation data set to a service provider as to a time when the service provider should recharge a vehicle, according to one or more embodiments. FIG. 2C illustrates another example method for determining a time during which a service provider should charge their vehicle, according to one or more embodiments. In describing example methods of FIG. 2A, FIG. 2B and FIG. 2C, reference may be made to elements of FIG. 1 for purpose of illustrating suitable components or functionality for implementing a step or sub-step being described.

With reference to FIG. 2A, in step 210, network system 100 receives a transport request in connection with an on-demand service provided by the network system. The transport request can specify request parameters that include a service start location and a service end location. The transport request can correspond to, for example, a request to the transport a person or shipment from a service start location to a service end location. Alternatively, the transport request can correspond to a request to pickup in item (e.g., groceries, medication, prepared food items, etc.) from the service start location (e.g., store, restaurant, etc.) to a service end location (e.g., location requester).

In step 220, network system determines a requisite distance a travel for the transport request. In examples, the requisite distance of travel 137 can be based on (i) an estimated travel distance for a service provider to reach a service start location from their current location, (ii) a trip distance 131, corresponding to an estimated distance of travel from the service start location to a service end location, and (iii) an after-trip charging distance 133, corresponding to an estimated distance of travel from the service end location to a recharging station. In some examples, the requisite distance of travel can be determined as a sum of the affirmation distances, with inclusion of an optional safety distance margin. Further, the requisite distance of travel can vary amongst available service providers, based on their current location and/or the type of charging station required by the service providers vehicle. For example, a hydrogen fueled service vehicle may have a greater after-trip charging distance 133 as compared to an EV because hydrogen fueling stations are more sparse. Additionally, service providers who drive EVs may be charge different rates for charging stations based on their vehicle, charging plan and electrical network that they choose to use. Thus, the after-trip charging distance 133 can also vary amongst service providers that operate EVs, as the network system may identify charging stations that are nearest to the service end location that are of a type that is compatible with the EV of the service provider and/or the preference of the service provider.

In step 230, the network system makes a determination as to whether a service provider is suitable for transport request. In step 232, the determination can be based on a comparison of the operational range of the service provider's vehicle and the requisite distance of travel for the transport request. For example, if the difference between the operational range 115 of the service provider's vehicle and the requisite distance of travel 137 for the service provider to fulfill the transport request is greater a predetermined safety margin, then the determination is made in step 236 that the service provider is suitable for the transport request. If however, the difference between the operational range of the service providers vehicle and the requisite distance of travel 137 is negative, or less than a safety margin, then determination made in step 236 is that the service provider is not suitable for the transport request.

Alternatively, the determination of whether the service provider is suitable for the transport request can be based on a preference of the service provider to charge the service providers vehicle at a particular charge level (e.g., the preferred restore point 111). This preference can be associated with the service providers profile information (as stored in a profile data store 114). In step 234, the determination as to whether the service provider is suitable for the transport request can be based on a comparison of a preferred operational range 119 of the service provider and the requisite distance of travel 137 for the service provider to fulfill the transport request. As described with other examples, the preferred operational range 119 can be based on a difference between the current operational level and the preferred restore point 111 of the service provider. If the difference between the preferred operational range 119 of the service provider's vehicle is greater than the requisite distance of travel 137 for the service provider to fulfill the transport request (and in accordance with some aspects with an added safety margin), then the determination is the made in step 236 that the service provider is suitable for the transport request. If however, the difference between the preferred operational range of the service providers vehicle and the requisite distance of travel 137 is negative, or less than an safety margin, then determination made in step 236 is that the service provider is not suitable for the transport request.

If the determination is made that the service provider is suitable for the transport request, then in step 240, the network system 100 performs operations to match the service provider to the transport request. In some examples, the operations can include sending the service provider an invitation to accept the transport request. In variations, the service provider can include included in a set of candidate service providers for the transport request, and the transport request is matched to one of the service providers of the candidate set.

If the determination is made that the service provider is not suitable for the transport request, then in step 242, the service provider is excluded from being matched to the transport request. For example, the network system 100 can perform a matching process with another service provider, or the network system 100 can exclude the service provider from the candidate set of service providers.

With reference to FIG. 2B, in step 250, the network system 100 can forecast a demand for a service provider in connection with the service provider providing transport services through an on-demand service of the network system. The demand for the service provider can be based on, for example, a number of transport requests that are expected to be matched to the service provider, a number of fares that the service provider may expect to receive, or the sum total of fares which the service provider can expect to earn. The demand can be forecasted for specific sub-intervals (or time slots) of an upcoming time interval (e.g., 8 or 12 hour time interval) that overlaps or coincides with a time period that the service provider intends to be available for the on-demand service. In some examples, the determination of demand for individual sub-intervals can be relative to the demand of other sub-intervals. For example, the determination of demand can correspond to the sub-interval with the greatest demand and/or the sub-interval with the least demand.

In step 260, based on the forecasted demand, one or more sub-intervals are identified as being optimal times for the service provider to recharge the service provider's EV. The determination of an optimal sub-interval can be with respect to an objective of the service provider, such as an objective to maximize utility of the service provider's vehicle and/or earnings (or net income) of the service provider.

In determining the optimal times for charging, in step 262, the network system 100 makes a determination as to a charging cost to the service provider at one or multiple sub-intervals during an upcoming time interval. For example, the determination can estimate the charging cost as being based on a published or learned (through monitoring) charging cost for service stations that may be utilized by the service provider. In variations, the determination of charging cost can further include indirect costs of charging, such as, for example, travel time to reach the charging station and/or an expected downtime of the service provider, coinciding with a time expended (or expected to be expended) by the service provider to charge their vehicle. The expected down-time can be based on one or more of (i) a current or predicted availability of stalls (e.g., number of stalls that are most likely to be available at a given time) at individual charging stations, (ii) an expected amount of time for the service provider to charge their vehicle, (iii) an expected amount of time for the service provider to travel to the charging station, and/or (iv) one or more tendencies (e.g., charging behavior) of the service provider.

As an addition or variation, in step 264, the network system 100 estimates an operational range of the service vehicle over the upcoming time interval. The network system 100 can determine one or more sub-intervals that are optimal for the service provider to charge based at least in part on the estimated operational range in upcoming sub-intervals. For example, if the network system 100 estimates that the service provider will run out of charge before a particular time, the network system 100 can predict the most optimal sub-interval before that particular time. As another example, if the most optimal sub-intervals for a service provider to charge his vehicle are at 4 PM and 8 PM, but the network system 100 determines that the service vehicle will run out of charge before 8 pm, then the network system 100 can recommend that the service provider charge his vehicle at 4 PM.

If the service provider does not charge his vehicle at the optimal sub-interval (e.g., such as in the case of the service provider being on a long trip during the optimal sub-interval), the network system 100 can determine a next-most optimal sub-interval. In variations, the determination of the next-most optimal sub-interval can be subject to occurring before the service provider's vehicle's operational range reaches a minimum threshold value.

With reference to FIG. 2C, in step 270, the network system 100 determines an upcoming session time for a service provider, reflecting a time interval during which the service provider is expected to utilize an on-demand transport service to provide, or be available to provide, transport services. The session time can, for example, correspond to a block of time during which the service provider operates an EV and provides, or is available to provide, transport services. Accordingly, the session time of a service provider can reflect a start and end time during which the service provider is available for or to provide transport services. As described with examples, a service provider can interact with an application interface of a service application 118 (e.g., FIG. 3J) to communicate an intended time slot during which they intend to be active and available for providing transport services. The application interface can enable the service provider to specify an end-time for their session, either before or after the service provider makes themself available to the network system 100.

In step 274, the network system 100 determines a probability score that is indicative of whether charging of a vehicle operated by a service provider will occur during the upcoming session time. The probability score can reflect, for example, a binary value (e.g., Boolean), a trinary value (e.g., yes, no, maybe), a probability percentage, etc. The determination can be based on a variety of factors, such as the current charge level or range of the service provider's vehicle and the length of the determined session time for the service provider. In examples, the factors can also include predictive determinations, such as the regions where the service provider is expected to operate, a number of transport requests that the service provider is expected to fulfill, and/or a distance that the service provider is expected to drive during the session time (e.g., based on an expected number of transport requests that the service provider fulfills and trip distance of transport requests the service provider fulfills). The predictive factors can be determined from historical information regarding the service provider and/or prior transport services provided for the regions where the service provider is expected to operate.

In step 278, the network system 100 determines a demand for a service provider to provide transport services at each of a plurality of sub-intervals of the upcoming session time. The sub-intervals can correspond to, for example, 15, 20, 30, or 60 minute blocks of time during the service provider's session time (e.g., 6 or 8 hour shift). The demand can be determined based on historical information regarding the number of transport requests that were fulfilled in the relevant geographic regions in the past. Additionally, the demand can be based on additional predictive factors such as the number of service providers that are currently available or expected to be available, as well as the number of requesters or potential requesters (e.g., requesters who have the service application open, but who have not requested transport) that are currently present in the relevant geographic regions. Further, contextual information, such as information about weather, holiday or relevant events (e.g., concerts) can also be used to predict demand over the sub-intervals of the upcoming session.

In step 282, the network system determines one or more sub-intervals during which time the service provider should charge their vehicle. The determination can be based on the determined demand for the sub-intervals during the current session, prior to a time when the service provider is expected to need charge. In some examples, the determination of sub-intervals for charging can also be based on the predicted cost for the service provider to charge their vehicle (e.g., based on predicted cost for service provider to charge their vehicle). Still further, as described with examples, the determination of sub-intervals for charging can be based on the predicted availability of charging stations (e.g., based on historical information relating to use of charging stations), traffic patterns, the expected location of the service provider and their proximity to desirable charging stations (e.g., fast chargers) and other factors that can affect the time needed for the service provider to charge their vehicle. In examples, the determination can be provided to the service provider as a recommendation, such as displayed through an application interface (e.g., FIG. 3C and FIG. 3D). The recommendation can also be optimized for an objective of the service provider (e.g., to maximize earning potential of the service provider).

### Example Interfaces

FIG. 3A through FIG. 3N illustrate example interfaces for use with one or more examples. The network system 100 can provide or transmit data to cause the service provider device to provide example interfaces such as described with FIG. 3A through FIG. 3N. Accordingly, reference may be made to elements of FIG. 1 for purpose of illustrating suitable components or elements for implementing functionality shown with examples of FIG. 3A through FIG. 3N.

With reference to an example of FIG. 3A, an interface 310 provides one or more recommendations 301 as to which charging station a service provider of an EV should use. The interface 310 can be generated in response to, for example, the network system 100 determining that the vehicle is at a low charge threshold. As an addition or variation, the interface 310 can be automatically generated upon the service provider being detected as completing the transport service, or nearing completion of the transport request. In an example, the interface 310 is displayed to a service provider when a determination is made that the service provider is low on charge. As an addition or variation, the interface 310 is displayed to a service provider upon the service provider completing, or nearing fulfillment of a transport request, and when the service provider is deemed to be low in charge.

The interface 310 can structure the recommendations 301 as a list of electric chargers 312 that are in proximity to (e.g., within a designated distance from) the current location of the service provider. The recommended charging stations 301 can be selected based on one or more criteria, such as proximity, the type of charging network, the cost of the charging station, the number of unoccupied charging stalls (or estimated wait time for an available charging station), the charging capacity of the charging station, the estimated cost to the service provider for using the charging station, the accessibility of the charging station, and/or amenities offered near the charging station which are preferred by the service provider. Further, the recommendations 301 of the list 312 can reflect a ranking by one or metrics, such as by distance or suitability. The entries of the list 312 can also include a badge or other indicator to identify a recommended charger. In some examples, the recommended charging station can be indicated to the user based on an objective or preference of the user, such as cost, proximity, availability, and speed to charge (e.g., based on a combination of factors, such as charging capacity of charging station, accessibility, proximity, and available stalls).

With reference to an example of FIG. 3B, an interface 320 provides a notification 322 to the service provider in regards to a charge level of the service provider. The notification 322 can reflect, for example, that the charge level 322 is below a threshold that is deemed required in order for the service provider to be matched to transport requests. Thus, for example, if the requisite distance of travel 137 for every open transport request is approximately equal to or greater than the operational range of the service provider's vehicle, the notification 322 can be rendered on the provider device 104 to inform the service provider that they will not be matched to another transport request, or at least limited in the number of transport requests which are matched to the service provider. The notification 322 can then be used to prompt the service provider to seek charging of the service vehicle. The interface 310 of FIG. 3A, for example, can be subsequently displayed to the service provider to guide the service provider to a recommended charging station, as described with examples of FIG. 3A.

With reference to an example of FIG. 3C, an interface 330 provides a recommendation 332 as to a time when the service provider should seek to charge their vehicle. The interface 330 can be generated as an overlay or otherwise superimposed over another application screen. In examples, the recommendation 332 can identify a sub interval (e.g., 2-3 PM) during which the service provider should seek to recharge the vehicle. The recommendation 332 can also provide content that identifies a basis for the recommendation (e.g., “charging cost and rider demand are lowest then.”) The recommendation 332 can also be represented as a selection of one or more sub-intervals of an upcoming time interval that overlaps with a time period when the service provider is expected to utilize the on-demand service to field and fulfill transport requests. In an example shown, a bar graph 334 illustrates the upcoming time interval, with discrete blocks 338 representing sub intervals (e.g., one hour blocks of time). Each block 338 can graphically indicate a relative earning potential of the service provider during the corresponding sub interval, where the earning potential is in reference to the net income the service provider can earn. The earning potentials for time slots can be determined from, for example, historical information relating to the demand for transport service in the relevant region of the service provider. A height of each block 338 can correlate to a forecast for the number of transport requests and/or fares that the service provider is expected to receive during the corresponding sub-interval of time. The recommended sub-intervals can be graphically indicated through coloring, shading or other graphic feature. In an example shown, multiple sub-intervals are shown as recommended (e.g., in darker or colored shading), with a degree of color/shading indicating a ranking of the recommended sub-interval. For example, the most recommended sub-interval can be darkest, while the next most recommended sub-interval can be a shade lighter, and non-recommended sub-intervals can have minimal or no shading.

As further shown in an example of FIG. 3C, the recommendation 332 is generated without consideration of the service provider's current or future operational range. However, in variations, the recommendation 332 can take into account an expected operational range of the service provider at one or more times over the course of the upcoming time interval. By taking into account the operational range of the service provider, the recommendation 332 can be tuned to reflect whether the service provider can wait for a particular sub-interval. For example, in the example shown by FIG. 3C, the alternative recommendation of 8 PM may be discarded if the network system 100 determines that there is a possibility the service provider vehicle will have inadequate operational range to handle transport requests before the 8 pm interval. In such case, the system can provide an alternative recommendation of 3 pm (rather than 8 pm) for the service provider.

Further, in examples, the interface 330 can be interactive, to enable the service provider to provide input that indicates his or her intent to charge the service provider's vehicle at the recommended time. If the service provider provides input to accept the recommended time to charge the service provider vehicle, the network system 100 can subsequently perform actions such as (i) sending reminder notifications to the service provider before or during the recommended time when charging is to take place, (ii) monitor the progress of the service provider towards a suitable charging station just before or during the time interval when charging is to take place; and/or (iii) automatically change the status of the service provider to pause.

FIG. 3D illustrates an alternative interface 340 for providing a recommendation 342 to the service provider as to when the service provider should seek to recharge his or her vehicle. In FIG. 3D, the interface 340 graphically represents multiple discrete sub-intervals of an upcoming time interval, with each sub-interval including a graphic representation or indication of the forecast earning potential for that sub-interval, as well as the expected cost for the service provider to charge his or her vehicle during the same sub-interval. As described with other examples, the forecasted earning potential can be based on a forecasted determination of the forecast component 138. The expected cost for the service provider to charge the vehicle during a particular sub-interval can be based on a published charging cost for a charging station that the service provider is expected to use.

As shown, the interface 340 includes a bar graph 346, where each sub-interval is represented as one of the bar elements 343 of the bar graph. A height of a first portion 345 of individual bar elements 346 can represent a forecasted earning potential for the service provider. A height of a second portion 347 of individual bar elements 343 can represent the expected charging cost for the service provider to charge his vehicle. The sub-intervals that are deemed optimal for the service provider (e.g., greatest potential net income, or forecast earnings less charging cost) can also be visually indicated through marking, shading, coloring or other visual characteristics.

With further reference to an example of FIG. 3D, the interface 340 can be generated in response to the service provider foregoing charging at the recommended time. For example, the network system 100 can monitor the status and location of the service provider to detect whether the service provider has missed, or will likely miss, charging his or her vehicle at the recommended time. Various reasons may exist for a service provider to miss the recommended charging time—the service provider may be fulfilling other transport requests, the service provider may temporarily signoff from the on-demand service during the recommended charging time, or the service provider may simply change his mind.

As further reflected by an example of FIG. 3D, in response to missing a recommended charging time, the network system 100 can generate the recommendation 342 to identify the next optimal sub-interval, and transmit a notification to the service provider to identify that sub-interval. The next sub-interval can also be based on the current operational range of the service provider, as well as prior or updated determinations of the availability of charging stations and/or the expected demand for the service provider.

FIG. 3E through FIG. 3G illustrate an example interface 350 that provides ongoing EV-specific service metric(s) 352 for the service provider. The EV-specific service metrics can identify the operational range (or charge level of the service provider) and/or an amount of activity that the service provider can perform before having to charge their vehicle. As described with other examples, the amount of activity can be based on the forecast determinations 139 of the network system 100.

In examples as shown, a metric 352 represents an estimate of the service activity that can be performed by the service provider before the service provider's vehicle is to be recharged. The service activity can correspond to, for example, the number of service requests (or trips) that the service provider can fulfill before having to charge their vehicle. The metric 352 can be based at least in part on, for example, the current operational range of the service provider's vehicle. an expected travel distance for transport requests the service provider may receive. An average or median distance of travel can be determined from historical information 129A, specific to the geographic area, time of day and other contextual information. In determining the metric 352, the network system can determine a ratio of the current operational range 115 for the service provider's vehicle, over the average distance of travel for the service requests that the service provider is expected to receive in one or more upcoming time intervals.

In examples, the metric 352 can be displayed once the service provider's vehicle depletes to a threshold charge or operational level. Further, in some examples, once the threshold level is reached, the interface 350 can determine and display the metric 352, to indicate to the service provider the number of trips the service provider has remaining before the service provider's vehicle is fully depleted, or alternatively, depleted beyond a preferred threshold).

Further, once the service provider's vehicle reaches a certain threshold level, the interface 350 on the service provider's device can display charging stations that are within a threshold distance of the service provider. Thus, for example, once the operational level of the service provider's vehicle reaches the threshold charge level, the interface 350 can provide the metric 352 over a map interface that identifies the location of nearby charging stations. Further, the interface 350 can determine information about the nearby service stations, such as the number of available stalls, the charging rate and other information.

Accordingly, in FIG. 3E, the interface 350 illustrates use of the interface 350 and metric 352 when the operational range of the service provider's vehicle is at a first level (e.g., about 50%). FIG. 3F illustrates use of the interface 350 and metric 352 after the service provider's vehicle has been driven to the point where the operational range is relatively low (e.g., 30%). FIG. 3G illustrates use of the interface 350 and metric 352 after the service provider's vehicle has been driven to the point where the operational range is very low (e.g., 10%).

In examples, the metric 352 can be determined in real-time and accessed by the service application of the service provider. With reference to FIG. 1, in some examples, the interface 350 can be provided using date provided by the network system 100. For example, the EV guide component 144 can determine the metric 352 based on the current operational level of the service provider's vehicle, as well as historical information that indicates the average distance of trips the service provider can expect to receive. Further, the EV guide component 344 can determine when the charging level or operational level of the service provider's vehicle reaches a threshold level. The ECN component 148 can determine the locations of nearby charging stations. Once the charge level or operational range of the service provider's vehicle is deemed to reach a certain threshold level, the provider device interface 110 can transmit data to the provider device 104 to cause the provider device to display the metric 352. Further, the device interface 110 can also display the locations of charging stations that are nearby (e.g., within a threshold proximity) to the location of the service provider. In this way, the service provider can continuously view the number of service requests (or trips) he can accept by viewing the metric 352, and have comfort knowing the location of nearby charging stations.

With reference to an example of FIG. 3H and FIG. 3I, respectively in FIG. 3H, an interface 360 displays a toggle switch panel 361 that a service provider can select to indicate that they wish to connect their EV to network 100. In addition, a connected vehicle 362 display displays vehicles that the service provider has already connected to network 100. In an example, interface 360 is generated when a service provider registers an input in their provider device 104 that indicates that they would like to proceed to an interface that would allow them to connect their EV to network 100. The service provider can use the toggle switch panel 361 to initiate the connection of their EV to network 100. Via the connection prompt 364 of interface 363, the service provider is presented with an interactive interface where they can provide an input to either allow or deny network 100 access to the service provider's EV information.

With reference to an example of FIG. 3J, an interface 370 displays in part an availability prompt 371 which notifies the service provider to provide their expected or planned period of availability using the availability time scroller 372. The interface 370 can be generated as an overlay or otherwise superimposed over another application screen. In an example, interface 370 is generated when the service provider makes themself available to the on-demand service (e.g., to start a session). When providing an expected or planned period of availability, the availability time scroller 372 records the service provider's input in units of time. For example, as displayed in FIG. 3J, the prompt can direct the service provider to indicate at what time during that day they expect to complete their session as a service provider. Based at least in part on the session time (as provided by the service provider), the current operational range of the EV used by the service provider, the network system 100 can determine a probability score that is indicative of whether charging of a vehicle operated by a service provider will occur during the upcoming time interval

With reference to an example of FIG. 3K, an interface 380 illustrates an alternative interface for providing a recommendation for a time when the service provider should seek to charge their vehicle. This recommendation can be based in part on a time interval derived from the expected or planned period of availability that the service provider provided. If the service provider opted to not provide an availability period, an assumed availability period determined by the EV guide component 144 can be used instead. In examples, the recommendation can identify a specific time within a sub interval of the service provider's availability (e.g., 3 PM) during which the service provider should seek to recharge their vehicle. The recommendation can also be represented as a selection of one sub-interval of an upcoming time interval that overlaps with the time interval when the service provider is expected to utilize the on-demand service to field and fulfill transport requests. As described with other examples, the recommendation can be based at least in part on market conditions for the transport service and/or expected charging cost for the service provider.

In an example shown, a bar graph 381 illustrates the upcoming time interval, with discrete blocks 383 representing sub intervals (e.g., one hour blocks of time). Each discrete block 383 can correlate to a forecast for the number of transport requests and/or fares that the service provider is expected to receive during the corresponding sub-interval of time. In conjunction with the forecast, each discrete block can be comprised of a first portion 384 and second portion 382, respectively corresponding to the estimated earnings and vehicle charging costs that the service provider can expect to incur during that sub-interval. The recommended subinterval can be graphically indicated through coloring, shading or another graphic feature. In an example shown, the recommended sub-interval is represented as charging sub-interval block 386 (e.g., in darker or colored shading), with a degree of color/shading relative to the other sub-intervals indicating that sub-interval as being the recommended sub-interval. For example, the recommended sub-interval can be darkest, while the non-recommended sub-intervals can have minimal or no shading.

As further shown in an example of FIG. 3K, in conjunction with the charging sub-interval block 386 on bar graph 381, the recommended charging time can be represented on a battery level time plot 385 as a charge level sub-interval point 387. Plotting the service provider's initial battery level, the battery level time plot 385 linearly plots the service provider's battery level relative to a scale (e.g., 0-100%) against the same time interval/sub-intervals of bar graph 381. At each of the subsequent charge level sub-intervals 388 a point is recorded along the linear plot which indicates the service provider's anticipated battery level for that sub-interval. The linear plot can be graphically indicated using a color scale, each progression along the linear plot chromatically changing in color or shade in correlation with each unit of the battery level scale. Grouping together sub-groups of contiguous time sub-intervals according to a particular color, each color indicates how close a service provider is to having an empty battery. A change in shade further defining the service provider's battery level. For example, within sub-intervals 11 AM-1 PM, green can be used to indicate that the service provider's battery level within this period, according to the forecast, will not need to be charged. Each unit of charge within that period being a different shade of green. Additionally, each charge level sub-interval 387 point can be graphically indicated as an emboldened point affixed to the linear plot. A graphical banner is also affixed to some circumferential region of the emboldened point, displaying the corresponding battery level for that point (e.g., Battery Level: 32%). For example, when the network 100 initially makes the recommendation to charge at a specific time, the interface 380 is rendered with both the charging sub-interval block 386 and the charge level sub-interval 387 point automatically displayed as shown in FIG. 3K. In another example, the interface 380 can be interactive. The service provider can select either a charging sub-interval block 386 or charge level sub-interval 387 point on the service provider's device. Selecting one automatically selects the other, generating an interface 380 for that selected time sub-interval.

Further, in examples, the interface 380 can be interactive, to enable the service provider to provide input that indicates his or her intent to charge the service provider's vehicle at the recommended time. If the service provider provides input to accept the recommended time to charge the service provider vehicle, the network system 100 can subsequently perform actions such as (i) sending reminder notifications to the service provider before or during the recommended time when charging is to take place, (ii) monitor the progress of the service provider towards a suitable charging station just before or during the time interval when charging is to take place; and/or (iii) automatically change the status of the service provider to pause.

With reference to an example of FIG. 3L, an interface 390 provides a notification 391 to the service provider device 104 regarding a charge level of the service provider's vehicle. The interface 390 can be generated as an overlay or otherwise superimposed over another application screen. The notification can be comprised of a charge level graphic 392. The charge level graphic 392 can communicate the charge percentage of the service provider's vehicle using chromatic labels to indicate one of at least two states that the service provider's charge level places them in relative to the trips available. For example, when the service provider still has enough charge to be able to complete some number of trips and reach a charging station, the charge level graphic 392 can be displayed in green. Inversely, when the service provider has reached a point where they need to charge after their next trip, the charge level graphic can be displayed in red. Further, notification 391 can include information pertaining to the charge level state that the service provider is in. For example, when the service provider is in a “green” state, the notification can include the distance remanning that the service provider can drive before charging, a number range of trips that the driver can make within that remanning distance, and the time that they are scheduled to charge at. Inversely, in the “red” state, notification 391 can include the distance remaining until charging and a prompt that instructs the service provider to “charge after your next trip.” In addition, the numerical display of the charge level graphic 392 can be accompanied by a graphic display which also communicates the charge level symbolically. For example, the charge level can be represented graphically as a ring. A filled ring representing a filled battery (e.g., 100%), any charge level that is less than full represented by chromatically distinguishing the amount of the ring that is filled from the region that is not. The colors chosen can coincide with the chromatic states mentioned previously.

With reference to an example of FIG. 3M, an interface 394 provides a notification 391 to the service provider device 104 regarding a charge level of the service provider's vehicle and the availability of trips within the charge level range. The interface 394 can be generated as an overlay or otherwise superimposed over another application screen. When the service provider reaches a charge level that places their vehicle below a threshold that would allow them to complete another trip, the notification 391 can display an interactive charging station panel 393 that suggests a charging station to the service provider. This notification can include messages stating things such as, “It's time to charge,” or “, There are no trips short enough for you to take.” The notification can also include information about the charging station. For example, how far the charging station is from the service provider, how many charging stalls are open, whether the charging station serves food, whether there are restrooms, and the price per unit charged. Interacting with interface 390, the service provider can provide an input via their service provider device 104 indicating they would like to “Go to recommended charger,” or they can select that they'd like to see other charging station options.

With reference to an example of FIG. 3N, an interface 395 provides an interactive EV charging display 396 that provides information about the service provider's EV as their EV is charging. Additional information about the charging station and nearby amenities can be displayed as well. Of the information displayed, a digital EV charge graphic 398 displays the service provider's current EV charge level as the EV is being charged. An example of this digital display would be a charge progression bar in the shape of a battery that progressively displays the current charge of the EV as it is being charged. The progression of charging can be displayed chromatically by indicating the EV's current charge in a color that contrasts with that of the backdrop of the symbolic battery container. Other information that can be displayed is a digital graphic showing EV charging metrics 397. For example, the time it would take for the service provider's vehicle to reach a particular charge percentage can be provided. The current cost of the charging transaction and the range gained as a result of the current charging transaction can also be displayed and updated during the charging transaction. Further, an interactive nearby amenities 399 panel can also be displayed. The service provider is able to find amenities that are near the charging station, some of which can include restaurants, cafes, etc.

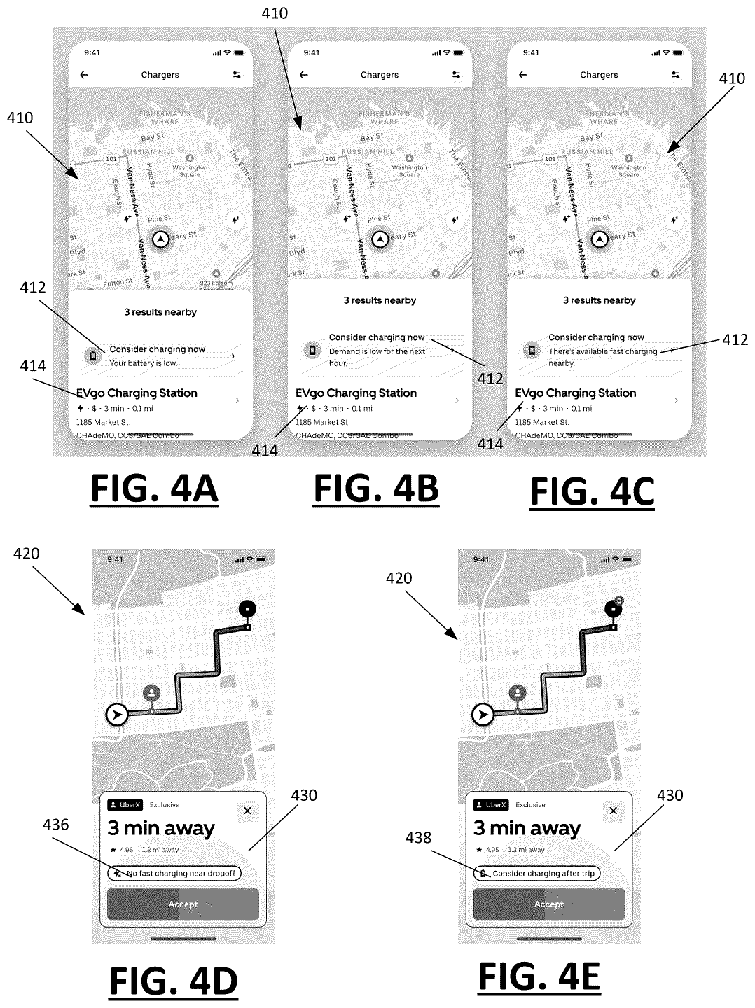

FIG. 4A through FIG. 4C illustrate examples of a service application interface 410 that integrates a recommendation 412 for a service provider to charge their vehicle. In an example shown, the recommendation 412 can be provided as an overlay or panel that surfaces over another interface (e.g., navigation). The recommendation 412 can include a recommended action (“consider charging now”) and a charging consideration which provides a justification or rational for the recommended action. Different recommendations and charging stations can be generated by the network system 100 and surfaced in different context on the provider device. In FIG. 4A through FIG. 4C, for example, each of the recommendations 412 are generated in response to a detected charging-related condition, which is reflected in the charging consideration. In an example of FIG. 4A, the charging consideration is battery level (“your battery is low”). In an example of FIG. 4B, the charging consideration is a market condition relating to the service provider's earning (“Demand is low for the next hour”). The charging consideration can be based on the network system 100 predicting that demand for transport services will be low in the upcoming time interval. In an example of FIG. 4C, the charging consideration is based on the user's location being in proximity to a particular type of charger (e.g., There's available fast charging nearby.”

FIG. 4D and FIG. 4E illustrate examples of a service interface 420 on which an invitation feature 430 is provided to enable a service provider to accept a transport request. The invitation feature 430 can include an exclusive offer for the user to accept a transport request, meaning the particular invitation is only communicated to the service provider. Alternatively, the invitation feature 430 can include a non-exclusive offer, where the service request is offered to multiple candidate service providers at one time. The service provider can interact with the invitation feature 430 to accept the represented transport request.

In an example of FIG. 4D, the invitation feature 430 includes a charging consideration 436 (e.g., “No fast charging near drop-off”). The charging consideration 436 can be included with the invitation feature 430 in order to facilitate the service provider's decision making with regards to accepting the invitation 430. In some examples, the charging consideration 436 is generated specifically for a charging condition of the service provider, such as the service provider's EV being in a low charge state. Thus, the charging consideration 436 can be specific to the service provider (or the service provider's EV).

In an example of FIG. 4E, the invitation feature 430 includes a recommendation 438 (e.g., “Consider charging after trip”). The recommendation 438 can be generated specifically for a service provider, in response to a determination that the service provider's EV is, or will be after fulfillment of the transport request, in a low charge state.

### Hardware Diagram

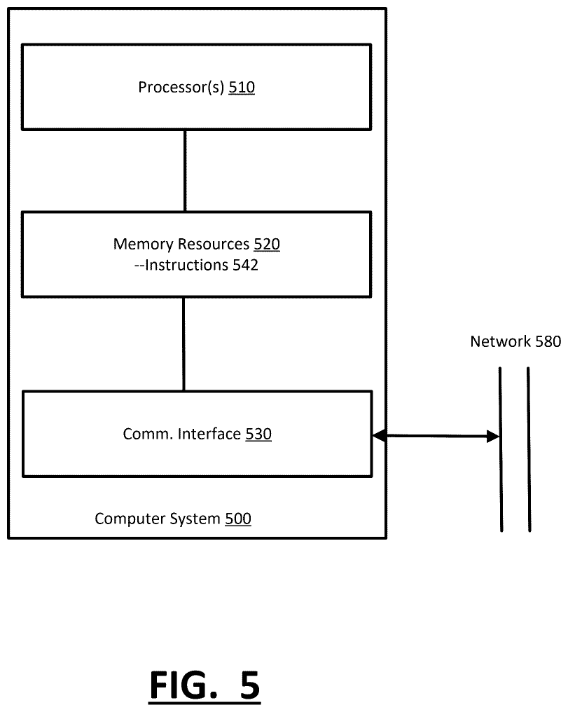

FIG. 5 is a block diagram that illustrates a network computing system upon which one or more embodiments described herein can be implemented. A network system 100 such as described an example of FIG. 1 can be implemented using a computing system 500 of FIG. 5. Further, example methods of FIG. 2A, FIG. 2B and FIG. 2C can be implemented using the computing system 500.

In one implementation, the computing system 500 includes one or more processors 510, memory resources 520, and a communication interface 530. The computer system 500 includes at least one processor 510 for processing information. The memory resources 520 may include a random access memory (RAM) or other dynamic storage device, for storing information and instructions to be executed by the processor(s) 510. The memory resources 520 also may be used for storing temporary variables or other intermediate information during execution of instructions to be executed by the processor(s) 510. The computer system 500 may also include other forms of memory resources, such as static storage devices for storing static information and instructions for the processor 510. The memory resources 520 can store information and instructions, including instructions 542 for communicating with user computing devices to receive position information, and for transmitting application content data to requester and service provider devices 102, 104.

The communication interface 530 can enable the computer system 500 to communicate with one or more networks 5480 (e.g., cellular network) through use of the network link (wireless or wireline). Using the network link, the computer system 500 can communicate with one or more other computing devices and/or one or more other servers or data centers. In some variations, the computer system 500 can receive service requests from requester devices via the network link 580. Additionally, the computer system 500 can receive information from provider devices, from which forecasts of provisioning levels, location bias and other aspects described herein may be determined.

Examples described herein are related to the use of the computer system 500 for implementing the techniques described herein. According to one embodiment, those techniques are performed by the computer system 500 in response to the processor 510 executing one or more sequences of one or more instructions contained in the memory resource 520. Such instructions may be read into a main memory from another machine-readable medium, such as a storage device. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

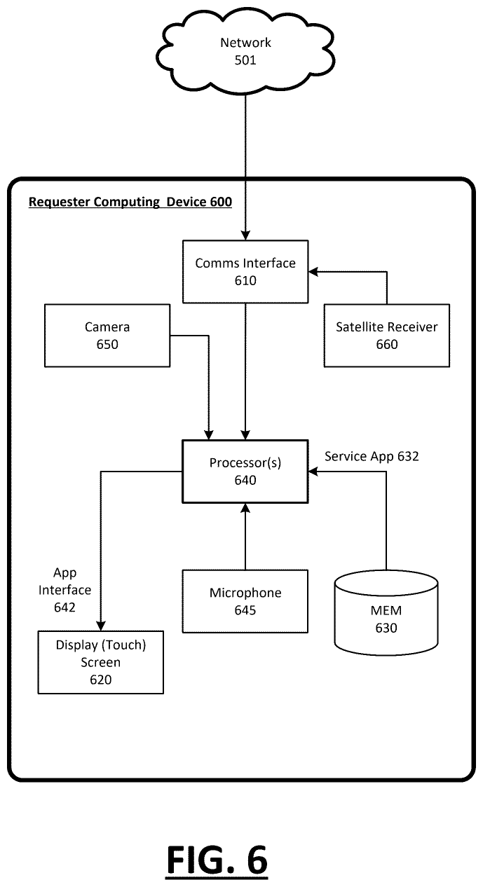

FIG. 6 is a block diagram illustrating an example user device for use with examples as described. In an example, a user device 600 can correspond to a requester device 102 or service provider device 104. As a service provider device 104, the user device can execute service application 118 for enabling the service provider to utilize an on-demand service provided by network computing system 100.

In many implementations, user device 600 can correspond to a mobile computing device, such as a smartphone, tablet computer, laptop computer, VR or AR headset device, and the like. As such, the user device 600 can include typical telephony and/or tablet features such as a microphone 645, a camera 650, a satellite receiver 660 to obtain geolocation information (e.g., longitude and latitude where device is located), and a communication interface 610 to communicate with external entities using any one or more wireless communication protocols (and over one or more networks). In certain aspects, the user device 600 can store the designated application (e.g., a service app 632 for service provider) in a local memory 630. In variations, the memory 630 can store additional applications executable by one or more processors 640 of the user device 600, enabling access and interaction with one or more host servers over one or more networks 680.

The service application 632 can interact with the user device 600 to display an application interface 642 on a display screen 620 of the user device 600. By way of example, the application interface 642 can be implemented as one or more of the interfaces of FIG. 3A through FIG. 3N and FIG. 4A through FIG. 4E, to allow the service provider to view information about charging and managing their EV.

### CONCLUSION

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors;
a memory to store instructions;
wherein the one or more processors execute the instructions to perform operations that include:
determining an upcoming session time during which the service provider is expected to utilize an on-demand transport service to provide, or be available to provide, transport services;
determining a probability score indicative of whether charging of a vehicle operated by a service provider will occur during the upcoming session time;
determining a demand for a service provider to provide transport services at each of a plurality of sub-intervals of the upcoming session time; and
based at least in part on the probability score, determining one or more sub-intervals of the plurality of sub-intervals for the service provider to charge the vehicle in order to optimize an objective of the service provider, wherein determining the one or more sub-intervals is based at least in part on the determined demand during one or more of the multiple sub-intervals.

2. The computer system of claim 1, wherein determining the probability score is based on an input of the service provider that indicates an expected duration of the upcoming session time.

3. The computer system of claim 2, wherein determining the probability score includes determining an operational range of the vehicle at a current time, and determining, from the input, an expected sign-off time of the service provider.

4. The computer system of claim 3, wherein determining one or more sub-intervals of the plurality of sub-intervals for the service provider to charge the vehicle includes predicting the charge level of the vehicle over the upcoming session time based at least in part on the current charge level.

5. The computing system of claim 1, wherein the objective of the service provider includes maximizing a usage of the vehicle to provide transport during the upcoming session time while minimizing a cost to recharge the vehicle.

6. The computing system of claim 5, wherein determining the one or more sub-intervals includes predicting a cost to the service provider to charge the vehicle at multiple instances during the upcoming session time, the predicted cost being based on a dynamic charging rate over the upcoming session time at one or multiple charging stations.

7. The computing system of claim 1, wherein determining one or more sub-intervals of the plurality of sub-intervals for the service provider to charge the vehicle includes predicting an amount of time for the service provider to charge the vehicle at a charging station.

8. The computing system of claim 7, wherein predicting the amount of time for the service provider to charge the vehicle is based at least in part on one or more of a charging capability of the charging station, a charging speed of the vehicle, and/or a tendency of the service provider.

9. The computing system of claim 8, wherein predicting the amount of time for the service provider to charge the vehicle includes estimating a second duration for the service provider to travel to and/or have access to a charger.

10. The computing system of claim 1, wherein the operations include:
transmitting data to a computing device of the service provider to cause the computing device to display information that indicates the one or more sub-intervals that are determined to optimize the objective of the service provider.

11. The computer system of claim 10, wherein determining the one or more sub-intervals incudes determining multiple sub-intervals of the plurality of sub-intervals that optimize the objective of the service provider as compared to other sub-intervals of the plurality of sub-intervals; and
wherein transmitting data to the computing device causes the computing device to display information that indicates each of the multiple sub-intervals.

12. The computer system of claim 10, wherein the operations include ranking the multiple sub-intervals based on the objective of the service provider.

13. The computer system of claim 1, wherein the operations include determining a number of service requests that the service provider is expected to be able to handle before having to charge their vehicle.

14. A computer-implemented method comprising:
determining a probability score indicative of whether charging of a vehicle operated by a service provider will occur during the upcoming session time;
determining a demand for a service provider to provide transport services at each of a plurality of sub-intervals of the upcoming session time; =and
based at least in part on the probability score, determining one or more sub-intervals of the plurality of sub-intervals for the service provider to charge the vehicle in order to optimize an objective of the service provider, wherein determining the one or more sub-intervals is based at least in part on the determined demand during one or more of the multiple sub-intervals.

15. The computer-implemented method of claim 14, wherein determining the probability score is based on an input of the service provider that indicates an expected duration of the upcoming session time.

16. The computer-implemented method of claim 15, wherein determining the probability score includes determining an operational range of the vehicle at a current time, and determining, from the input, an expected sign-off time of the service provider.

17. The computer-implemented method of claim 16, wherein determining one or more sub-intervals of the plurality of sub-intervals for the service provider to charge the vehicle includes predicting the charge level of the vehicle over the upcoming session time based at least in part on the current charge level.

18. The computing system of claim 14, wherein the operations include:
transmitting data to a computing device of the service provider to cause the computing device to display information that indicates the one or more sub-intervals that are determined to optimize the objective of the service provider.

19. The computer-implemented method of claim 18, wherein determining the one or more sub-intervals incudes determining multiple sub-intervals of the plurality of sub-intervals that optimize the objective of the service provider as compared to other sub-intervals of the plurality of sub-intervals; and
wherein transmitting data to the computing device causes the computing device to display information that indicates each of the multiple sub-intervals.

20. A non-transitory computer-readable medium that stores instructions, which when executed by one or more processors of a computer system, cause the computer system to perform operations that include:
determining an upcoming session time during which the service provider is expected to utilize an on-demand transport service to provide, or be available to provide, transport services;
determining a probability score indicative of whether charging of a vehicle operated by a service provider will occur during the upcoming session time;
determining a demand for a service provider to provide transport services at each of a plurality of sub-intervals of the upcoming time interval; and
based at least in part on the probability score, determining one or more sub-intervals of the plurality of sub-intervals for the service provider to charge the vehicle in order to optimize an objective of the service provider, wherein determining the one or more sub-intervals is based at least in part on the determined demand during one or more of the multiple sub-intervals.
